(19) United States
(12) Patent Application Publication
(10) Pub. No.: US 2025/0200884 A1
(43) Pub. Date: Jun. 19, 2025

(54) GENERATING ROAD LINES IN A THREE-DIMENSIONAL DIGITAL ROADBED

(71) Applicant: Toyota Jidosha Kabushiki Kaisha, Aichi-ken (JP)

(72) Inventor: Ioannis Stamos, New York, NY (US)

(73) Assignee: Toyota Jidosha Kabushiki Kaisha, Aichi-ken (JP)

(21) Appl. No.: 18/539,061

(22) Filed: Dec. 13, 2023

(51) Int. Cl. G06T 17/05; G01C 21/36; G06T 7/13; G06V 10/762; G06V 20/56

(52) U.S. Cl. CPC G06T 17/05; G01C 21/3635; G01C 21/367; G06T 7/13; G06V 10/762; G06V 20/588

(57) ABSTRACT

A method for generating road lines in a three-dimensional digital roadbed comprises: receiving a first two-dimensional image of a roadbed; identifying a first plurality of road line pixels in the first two-dimensional image of the roadbed, wherein each road line pixel of the first plurality of road line pixels corresponds to an identified road line of the first two-dimensional image; identifying a first plurality of road line three-dimensional points in the three-dimensional digital roadbed corresponding to the first plurality of road line pixels of the first two-dimensional image of the roadbed; clustering at least some road line three-dimensional points of the first plurality of road line three-dimensional points into a first three-dimensional point cloud; generating a first medial axis from the first three-dimensional point cloud; and generating, using the first medial axis, a first generated road line in the three-dimensional digital roadbed.

### BACKGROUND

### Field

The present disclosure generally relates to generating road lines in a three-dimensional digital roadbed, and more specifically, to systems, methods, and non-transitory computer-readable mediums for generating road lines in a three-dimensional digital roadbed.

### Technical Background

Modern vehicles increasingly utilize three-dimensional digital roadbeds for purposes such as automated-driving and determining vehicle routes, and such three-dimensional roadbeds may include road lines (for example, shoulder lines, median lines, lane lines, etc.) of roadbeds (that is to say, actual roadbeds; for example, streets, roads, highways, etc.) which the three-dimensional digital roadbeds represent to, for example, inform automated-driving systems or routing systems of such modern vehicles. However, three-dimensional digital roadbeds suitable for such purposes may not be publicly available. Further, generating road lines in a three-dimensional roadbed based on, for example, publicly available street maps may not provide an accurate three-dimensional digital roadbed due to, for example, a lack of precision of such publicly available street maps, changes to a roadbed which the street map depicts (for example, widening of a road, changing of lanes, or other changes resulting in road lines of a roadbed), and other related inaccuracies. Accordingly, a need exists for systems, methods, and non-transitory computer readable mediums which may generate road lines in a three-dimensional digital roadbed SUMMARY

According to a first embodiment a method for generating road lines in a three-dimensional digital roadbed comprises: receiving a first two-dimensional image of a roadbed; identifying a first plurality of road line pixels in the first two-dimensional image of the roadbed, wherein each road line pixel of the first plurality of road line pixels corresponds to an identified road line of the first two-dimensional image; identifying a first plurality of road line three-dimensional points in the three-dimensional digital roadbed corresponding to the first plurality of road line pixels of the first two-dimensional image of the roadbed; clustering at least some road line three-dimensional points of the first plurality of road line three-dimensional points into a first three-dimensional point cloud, generating a first medial axis from the first three-dimensional point cloud; and generating, using the first medial axis, a first generated road line in the three-dimensional digital roadbed.

According to a second embodiment, a system for generating road lines in a three-dimensional digital roadbed comprises: a memory component which stores a first two-dimensional image of a roadbed and the three-dimensional digital roadbed; a road line pixel identifier which identifies a first plurality of road line pixels in the first two-dimensional image of the roadbed, wherein each road line pixel of the first plurality of road line pixels corresponds to an identified road line of the first two-dimensional image; an image translator which identifies a first plurality of road line three-dimensional points in the three-dimensional digital roadbed corresponding to the first plurality of road line pixels of the first two-dimensional image of the roadbed; and a three-dimensional point cloud generator which performs at least the following: clustering at least some road line three-dimensional points of the first plurality of road line three-dimensional points into a first three-dimensional point cloud, generating a first medial axis from the first three-dimensional point cloud, and generating, using the first medial axis, a first generated road line in the three-dimensional digital roadbed.

According to a third embodiment, a non-transitory computer-readable medium stores logic that, when executed by a processor, causes the processor to perform at least the following: receiving, by a memory component, a first two-dimensional image of a roadbed; identifying, by a road line pixel identifier, a first plurality of road line pixels in the first two-dimensional image of the roadbed, wherein each road line pixel of the first plurality of road line pixels corresponds to an identified road line of the first two-dimensional image; identifying, by an image translator, a first plurality of road line three-dimensional points in the three-dimensional digital roadbed corresponding to the first plurality of road line pixels of the first two-dimensional image of the roadbed; clustering, by a three-dimensional point cloud generator, at least some road line three-dimensional points of the first plurality of road line three-dimensional points into a first three-dimensional point cloud; generating, by the three-dimensional point cloud generator, a first medial axis from the first three-dimensional point cloud; and generating, by the three-dimensional point cloud generator and using the first medial axis, a first generated road line in the three-dimensional digital roadbed.

Additional features and advantages of the aspects described herein will be set forth in the detailed description which follows, and in part will be readily apparent to those skilled in the art from that description or recognized by practicing the aspects described herein, including the detailed description, which follows, the claims, as well as the appended drawings.

It is to be understood that both the foregoing general description and the following detailed description describe various aspects and are intended to provide an overview or framework for understanding the nature and character of the claimed subject matter. The accompanying drawings are included to provide a further understanding of the various aspects, and are incorporated into and constitute a part of this specification. The drawings illustrate the various aspects described herein, and together with the description serve to explain the principles and operations of the claimed subject matter.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, wherein like structure is indicated with like reference numerals and in which:

FIG. 1 depicts a flow diagram of a first embodiment of a method for generating road lines in a three-dimensional digital roadbed, according to one or more embodiments shown and described herein;

FIG. 2A depicts a vehicle traversing a roadbed, according to one or more embodiments shown and described herein;

FIG. 2B depicts a two-dimensional image of the roadbed of FIG. 2A captured by the vehicle of FIG. 2A, according to one or more embodiments shown and described herein;

FIG. 3 schematically depicts hardware for generating road lines in a three-dimensional digital roadbed, according to one or more embodiments shown and described herein;

FIG. 4 depicts a close-up view of pixels of a portion of the two-dimensional image of the roadbed of FIG. 2B, according to one or more embodiments shown and described herein;

FIG. 5A depicts a close-up view of three-dimensional points of a portion of a three-dimensional digital roadbed, according to one or more embodiments shown and described herein;

FIG. 5B depicts a three-dimensional point cloud in a portion of a three-dimensional digital roadbed and a medial axis generated from the first three-dimensional point cloud, according to one or more embodiments shown and described herein;

FIG. 6 depicts a road line generated using a medial axis in a portion of a three-dimensional digital roadbed, according to one or more embodiments shown and described herein;

FIG. 7 depicts a plurality of generated road lines in a three-dimensional digital roadbed, according to one or more embodiments shown and described herein;

FIG. 8 depicts a flow diagram of a second embodiment of the method for generating road lines in a three-dimensional digital roadbed of FIG. 1, according to one or more embodiments shown and described herein;

FIG. 9A depicts a first three-dimensional point cloud and a second three-dimensional point cloud in a portion of a three-dimensional digital roadbed, according to one or more embodiments shown and described herein;

FIG. 9B depicts a combined three-dimensional point cloud formed from the first three-dimensional point cloud and the second three-dimensional point cloud of FIG. 9A and a medial axis formed from the combined three-dimensional point cloud in the portion of the three-dimensional digital roadbed of FIG. 9A, according to one or more embodiments shown and described herein; and

FIG. 10 depicts a first three-dimensional point cloud in a first portion of a three-dimensional digital roadbed, a second three-dimensional point cloud in a second portion of the three-dimensional digital roadbed, a first medial axis generated from the first three-dimensional point cloud, and a second medial axis generated from the second three-dimensional point cloud, according to one or more embodiments shown and described herein.

### DETAILED DESCRIPTION

The present disclosure, in one form, is related to systems, methods, and non-transitory computer-readable mediums for generating road lines in a three-dimensional digital roadbed. The systems, methods, and/or non-transitory computer-readable mediums described herein include components, steps, and/or logic that receive a two-dimensional image of a roadbed and generate, from the two-dimensional image of the roadbed, one or more generated road lines in a three-dimensional digital roadbed. Embodiments of the methods described herein include steps of receiving a two-dimensional image of a roadbed; identifying a plurality of road line pixels in the two-dimensional image of the roadbed; identifying a plurality of road line three-dimensional points in the three-dimensional digital roadbed corresponding to the plurality of road line pixels of the two-dimensional image of the roadbed; clustering at least some of the road line three-dimensional points of the plurality of road line three-dimensional points into a three-dimensional point cloud, generating a medial axis from the three-dimensional point cloud; and generating, using the medial axis, a generated road line in the three-dimensional digital roadbed. Embodiments of the systems described herein include a memory component which stores a two-dimensional image of a roadbed and a three-dimensional digital roadbed; a road line pixel identifier which identifies a plurality of road line pixels in the two-dimensional image of the roadbed; an image translator which identifies a plurality of road line three-dimensional points in the three-dimensional digital roadbed corresponding to the plurality of road line pixels of the two-dimensional image of the roadbed; and a three-dimensional point cloud generator which performs at least the following: clustering at least some road line three-dimensional points of the first plurality of road line three-dimensional points into a first three-dimensional point cloud, generating a first medial axis from the first three-dimensional point cloud, and generating, using the first medial axis, a first generated road line in the three-dimensional digital roadbed. Embodiments of the non-transitory computer-readable mediums described herein store logic that, when executed by a computing device, causes the computing device to perform at least the following: identify a plurality of road line pixels in the two-dimensional image of the roadbed; identify a plurality of road line three-dimensional points in the three-dimensional digital roadbed corresponding to the plurality of road line pixels of the two-dimensional image of the roadbed; cluster at least some of the road line three-dimensional points of the plurality of road line three-dimensional points into a three-dimensional point cloud; generate a medial axis from the three-dimensional point cloud; and generate, using the medial axis, a generated road line in the three-dimensional digital roadbed.

It should be understood that the term “road line” as used herein refers to any line (for example, shoulder lines, median lines, lane lines, etc.) painted, formed from, or otherwise defining a roadbed, and “road line” further refers to any other demarcated boundary of part or all of a roadbed (for example, a wall defining an edge of a roadbed and/or a lane thereof). Accordingly, the term “road line” as used herein is not limited to strictly linear and/or continuous formations as, in roadbeds, road lines may be curved (about, for example, a turn in a roadbed) or discontinuous (for example, in the case of median road lines). It should be understood that the term “roadbed” as used herein refers to some or all of any road, street, lane, highway, boulevard, alley, byway, parkway, or other such surface which may be traversed by a vehicle and defined, at least in part, by road lines as defined herein. It should be understood that the term “roadbed” as used herein refers to an actual roadbed (rather than, for example, a digital roadbed which digitally recreates the actual roadbed) unless otherwise modified by phrases such as “digital,” “three-dimensional,” and/or “two-dimensional.”

It should be understood that the term “three-dimensional digital roadbed” as used herein refers to a digital roadbed defined by three dimensions (for example, x-axis coordinates, y-axis coordinates, and z-axis coordinates). It should be understood that the term “two-dimensional image” as used herein refers to an image which may be defined by only two dimensions (for example, x-axis coordinates and y-axis coordinates). It should be understood that the terms “three-dimensional” and “3D” may be used interchangeably herein and that the terms “two-dimensional” and “2D” may be used interchangeably herein.

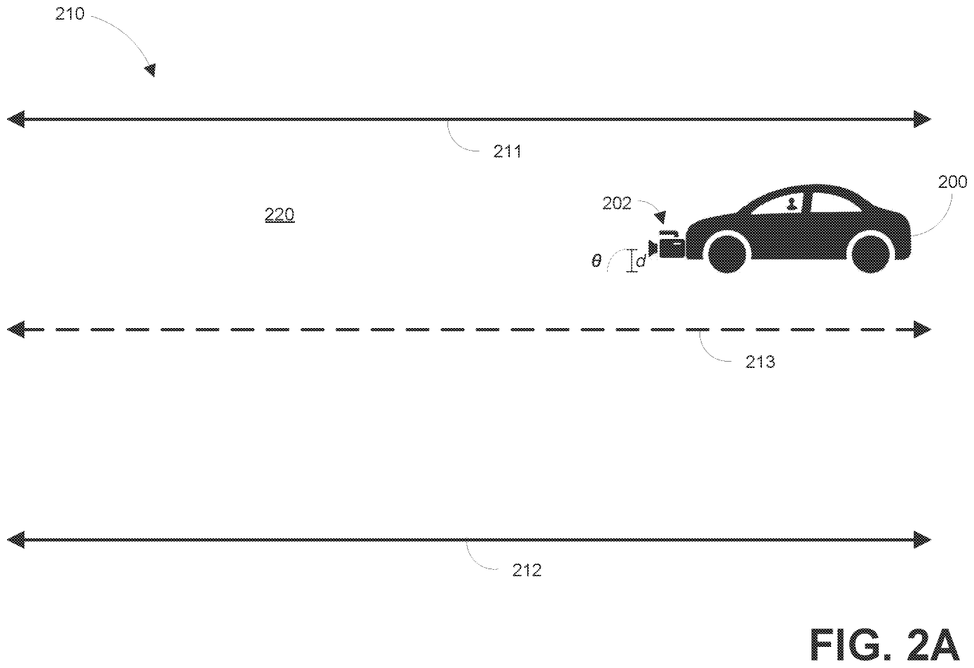

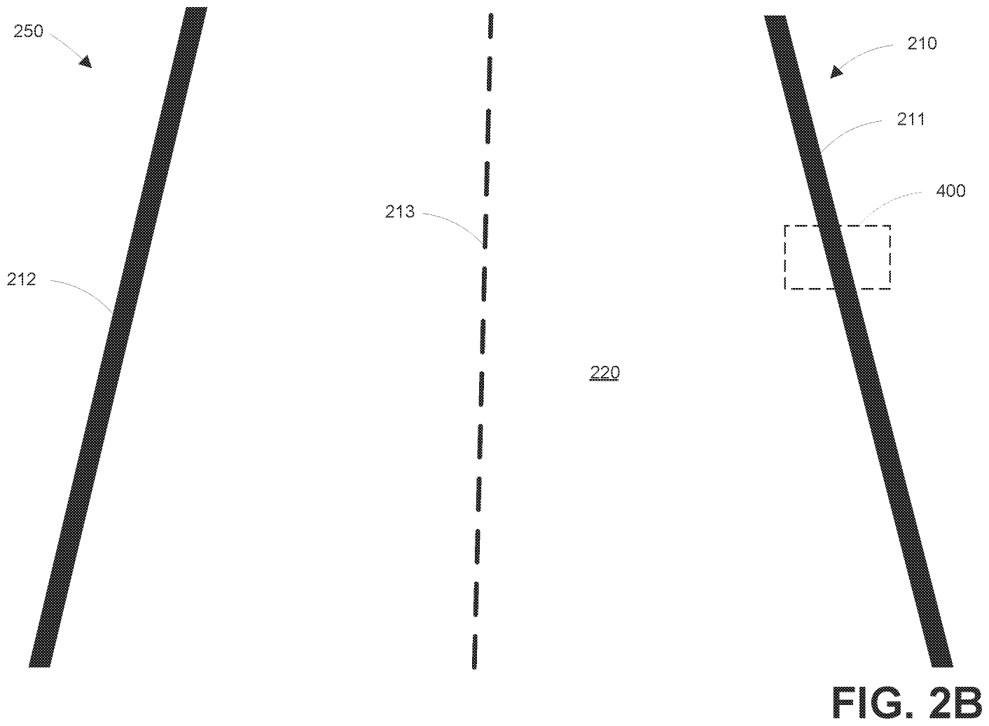

An advantage of the present disclosure is that the various embodiments of the systems, methods, and/or non-transitory computer-readable mediums described herein improve upon typical solutions in that embodiments may automatedly generate road lines in a 3D digital roadbed using hardware already existing in many modern vehicles. Many modern vehicles include external image-sensing devices (for example, an image-sensing device 202, described elsewhere herein and depicted in FIG. 2A) which may capture 2D images of a roadbed. By generating road lines in a 3D digital roadbed using one or more of such 2D images, such generation of road lines may be conducted by various embodiments of the systems, methods, and/or non-transitory computer-readable mediums described herein without requiring independent or additional mechanisms for gathering such 2D images aside from such pre-existing image-sensing devices on modern vehicles.

Another advantage of the present disclosure is that the various embodiments of the systems, methods, and/or non-transitory computer-readable mediums described herein may generate one or more road lines in a 3D digital roadbed from only a single 2D image. That is to say, various embodiments of the systems, methods, and/or non-transitory computer-readable mediums described herein may not require a plurality 2D images (for example, image clusters) or video to generate road lines in a 3D digital roadbed. However, this should not be construed as limiting any of the various embodiments of the systems, methods, and/or non-transitory computer-readable mediums described herein as being incapable of utilizing multiple 2D images and/or video to generate road lines in a 3D digital roadbed; rather, it should be understood that various embodiments described herein may not be limited to requiring the input, usage, or otherwise reference of a plurality of 2D images to generate road lines in a 3D digital roadbed.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

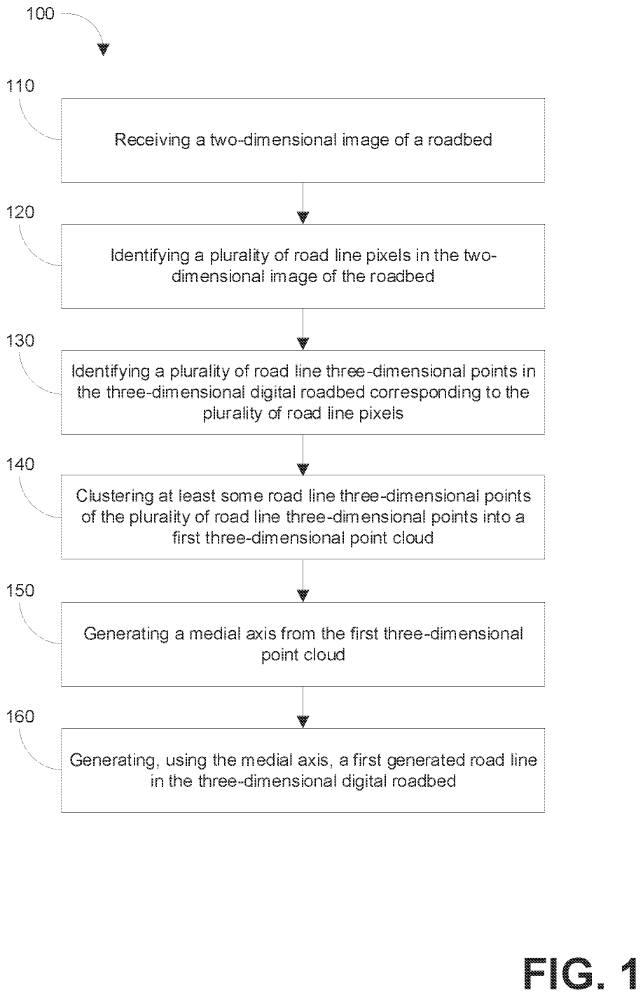

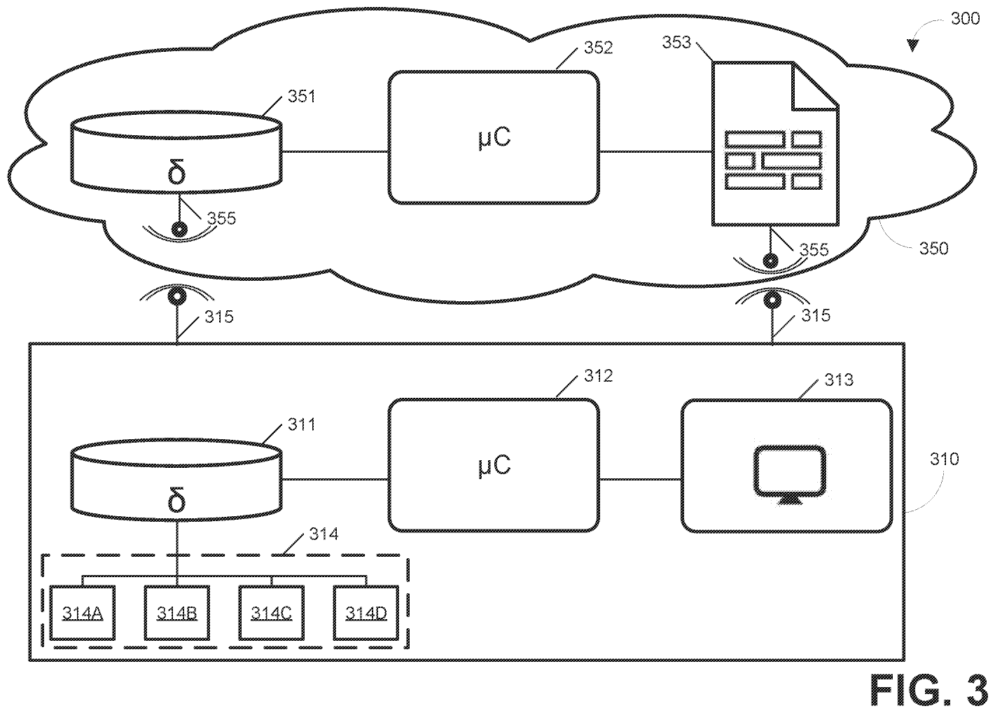

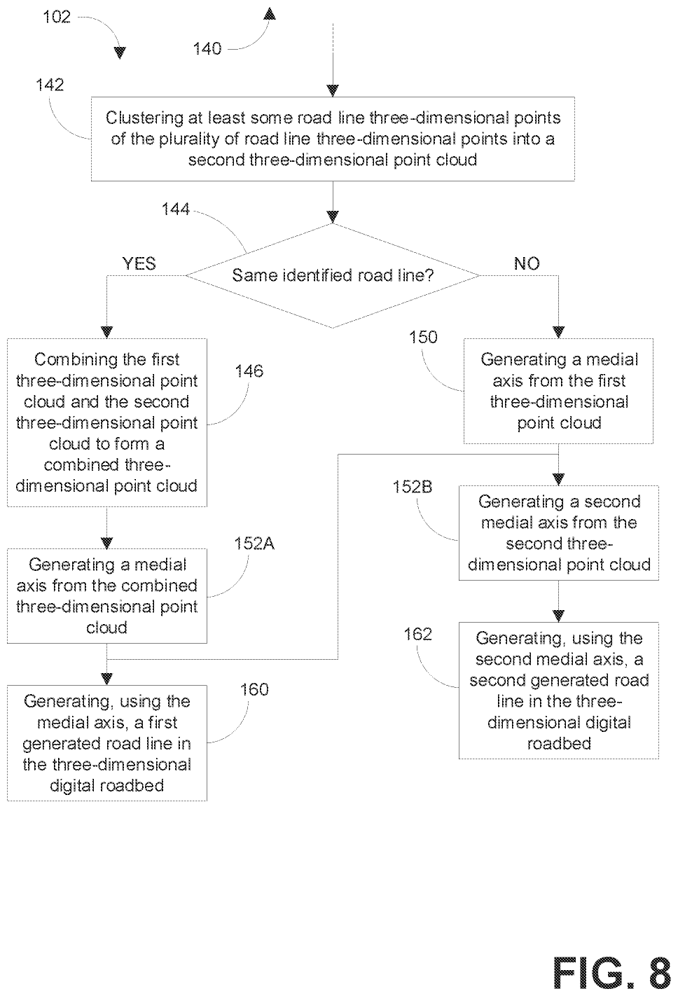

Turning now to the drawings, FIG. 1 depicts a flow diagram of an illustrative method 100 for generating road lines in a three-dimensional digital roadbed. While the method 100 of FIG. 1 generally relates to use of the specific systems (for example, a system 300, described elsewhere herein and depicted in FIG. 3) and/or non-transitory computer-readable mediums (which, for example, when executed by a computing device, such as a computing device 310 depicted in FIG. 3 and described elsewhere herein, may cause the computing device to execute embodiments of either or both of the method 100 and/or a method 102, which is described elsewhere herein and depicted in FIG. 8) described herein, it should be understood that a similar process may be used for other systems or computer-readable mediums.

Referring to FIG. 1 and with reference to FIGS. 2A-2B, the method 100 may include receiving a 2D image 250 of a roadbed 210, as described herein at block 110. In embodiments, the step of the block 110 may include receiving a single 2D image 250 of the roadbed 210. In embodiments, the step of the block 110 may include receiving a plurality of 2D images 250 of the roadbed 210 (in the form of, for example, frames of a video of the roadbed 210, a cluster of images taken at various times and/or positions along the roadbed 210, and/or in other forms). In embodiments, the step of the block 110 may include receiving a plurality of 2D images 250 wherein one or more of the 2D images 250 depict the roadbed 210 and one or more other 2D images of the 2D images 250 depict one or more additional roadbeds, distinct from the roadbed 210.

Referring to FIG. 2A, the 2D image 250 of the roadbed 210 may be captured by an image-sensing device 202 of a vehicle 200 as the vehicle 200 traverses the roadbed 210 (for example, leftward in the embodiment depicted in FIG. 2A). In the embodiment of FIG. 2A, the vehicle 200 is driving in a lane 220 of the roadbed 210. The roadbed 210 includes a first shoulder road line 211, a second shoulder road line 212, and a median road line 213, wherein the median road line 213 and the first shoulder road line 211 define the lane 220. However, it should be understood that embodiments of the present disclosure are not limited to only depicting roadbeds having two lanes, such as the roadbed 210. Rather, the embodiment of the roadbed 210 depicted in FIG. 2A is illustrated and simplified compared to other potential roadbeds (having, for example, three or more lanes, differing pluralities of road lines, and/or differing types of road lines).

In embodiments, the image-sensing device 202 may include one or more vehicle sensors which may, independently and/or collectively, capture one or more two-dimensional images of the roadbed 210, such as, in embodiments, one or more cameras, one or more radar sensors, one or more light detection and ranging (“LiDAR”) sensors, one or more other image-sensing devices (as are known in the art), and/or any combination thereof. Further, while the image-sensing device 202 is, in the embodiment depicted in FIG. 2A, forward-facing on the vehicle 200, in other embodiments, the image-sensing device 202 may include one or more image-sensing devices, such as those described above, of which any, some, or all may be positioned anywhere on the vehicle 200, oriented in any direction relative to the travel of the vehicle 200, and/or any combination thereof. In the embodiment of FIG. 2A, the vehicle 200 may be a car.

In other embodiments, the vehicle 200 may instead be another vehicle, such as, in embodiments, a truck, machinery, a boat or other water-faring vessel, a plane, a helicopter, and/or any other type of vehicle. Further, in embodiments, 2D images of the roadbed 210 used by various embodiments of the systems, methods, and/or non-transitory computer-readable mediums described herein may not be taken by an image-sensing device of a vehicle. Rather, in embodiments, a source of 2D images used by various embodiments of the systems, methods, and/or non-transitory computer-readable mediums described herein may not affect the generation of road lines in a 3D digital roadbed by embodiments of such systems, methods, and/or non-transitory computer-readable mediums.

Referring to FIG. 2B, the 2D image 250 of the roadbed 210 can be seen to depict each of the road lines 211, 212, 213. However, in other embodiments the 2D image 250 may depict any plurality of road lines of the roadbed 210. Further, in embodiments, the 2D image 250 may not depict every road line of the roadbed 210 (for example, in embodiments wherein the roadbed 210 has many lanes), and may, instead, only depict one or some road lines of the roadbed 210.

Referring now to FIG. 3, in embodiments, a system 300 for generating road lines in a 3D digital roadbed may include a computing device 310. In embodiments, the computing device 310 may include a memory component 311 (for example, a non-transitory computer-readable medium and/or a data memory), a 3D road line generation input monitor 312, a user interface 313 (for example, a digital and/or physical interface by which a user may interact with and/or instruct the computing device 310), and/or subsystems 314 for generating road lines in a 3D digital roadbed. In embodiments, the computing device 310 may include or be coupled (via, for example, Wi-Fi, WiMax, LTE, 4G, 5G, 6G, Bluetooth, Zigbee, and/or other wired and/or wireless connection systems) to one or more transceivers 315 (any, some, or all of which may, in embodiments, be configured as a transmitter, receiver and/or a transceiver) via which the computing device 310 may, in embodiments, receive the 2D image 250 and/or any other inputs of the 3D road line generation input monitor 312. Depending on the embodiment, the computing device 310 may receive sensor data from dozens, hundreds, or even thousands of different pieces of hardware including any, some, or all of hardware located on or within the vehicle 200, the image-sensing device 202, hardware located on or within one or more other vehicles (including, in embodiments, dozens, hundreds, or even thousands of different vehicles), one or more other image-sensing devices (including, in embodiments, dozens, hundreds, or even thousands of different image-sensing devices), and/or any combination thereof.

In embodiments, the memory component 311 (denoted in FIG. 3 as 8) may store data corresponding to the 2D image 250 and/or one or more other images received by the computing device 310 (from, in embodiments, any, some, or all of the vehicle 200, the image-sensing device 202, one or more other vehicles, one or more other image-sensing devices, and/or any combination thereof and/or via, in embodiments, the transceivers 315). Depending on the particular embodiment, the memory component 311 may be configured as random access memory (RAM), read only memory (ROM), registers, a database, and/or other hardware for storing data corresponding to the 2D image 250 and/or one or more other images. As such, the memory component 311 may be part of a broader memory component of the computing device 310, a data storage component, and/or part of other data storage infrastructure. In embodiments, the memory component 311 may store the subsystems 314 as, for example, logic. However, in other embodiments, the subsystems 314 may be stored in another data memory and/or may include hardware. In embodiments, any, some, or all of the subsystems 314 (for example, any, some, or all of a road line pixel identifier 314A, an image translator 314B, a 3D point cloud generator 314C, and/or a 3D digital roadbed generator 314D, as described in further detail elsewhere herein) may be, include, or store logic which performs the functions of each respective subsystem of the subsystems 314, as described elsewhere herein.

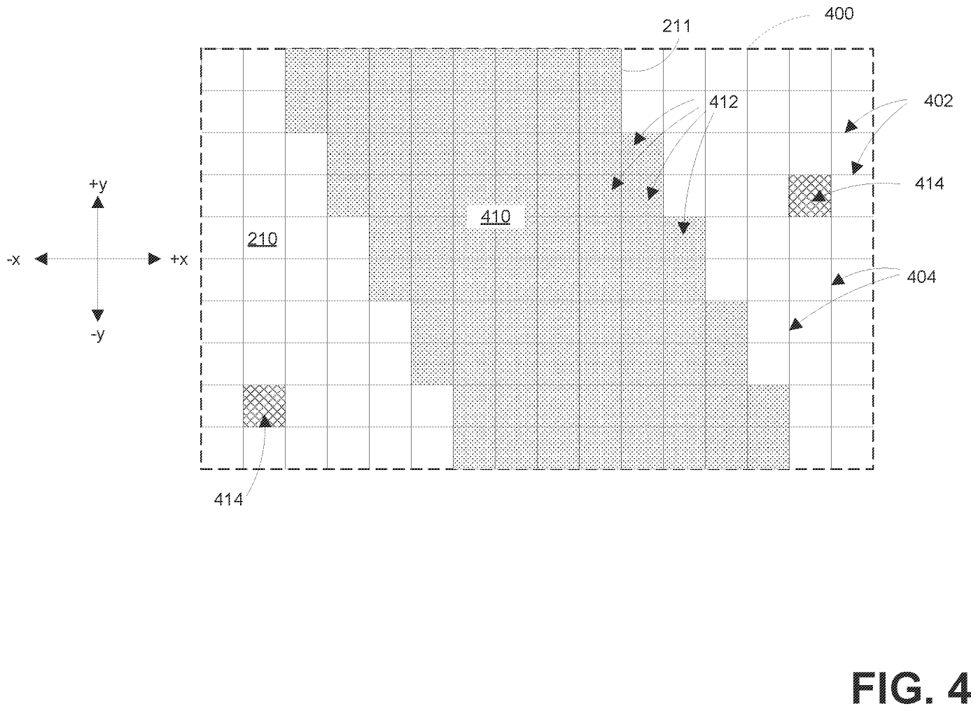

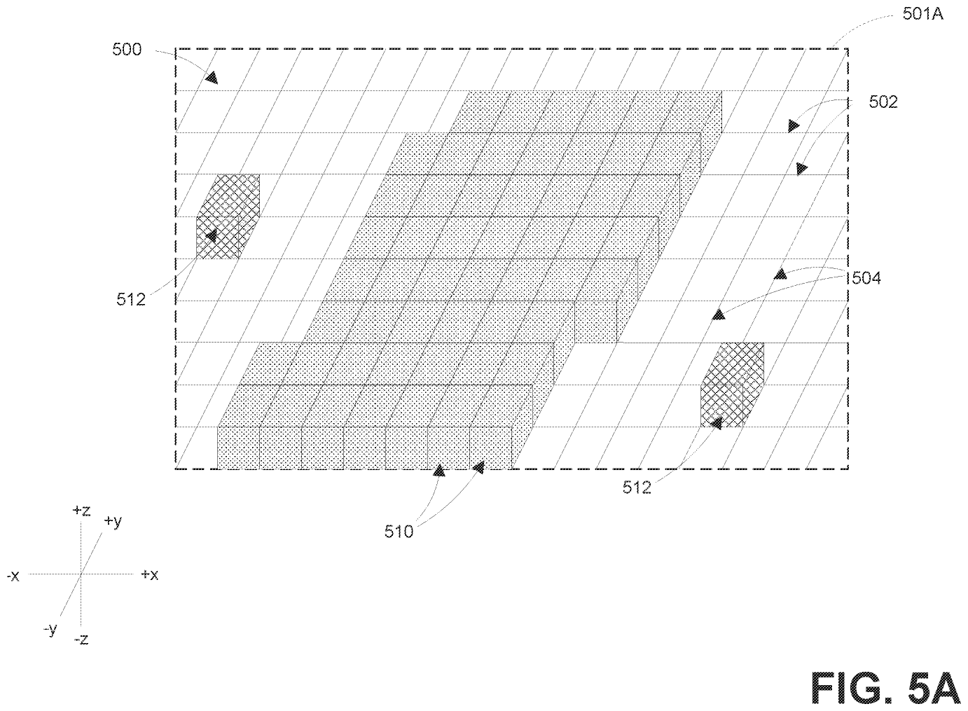

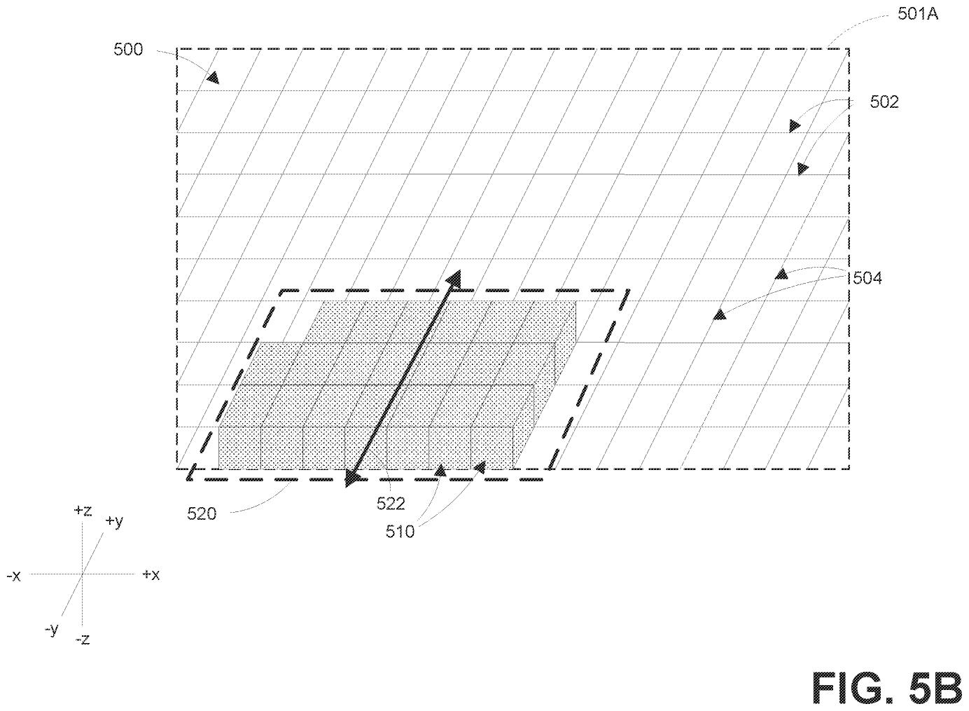

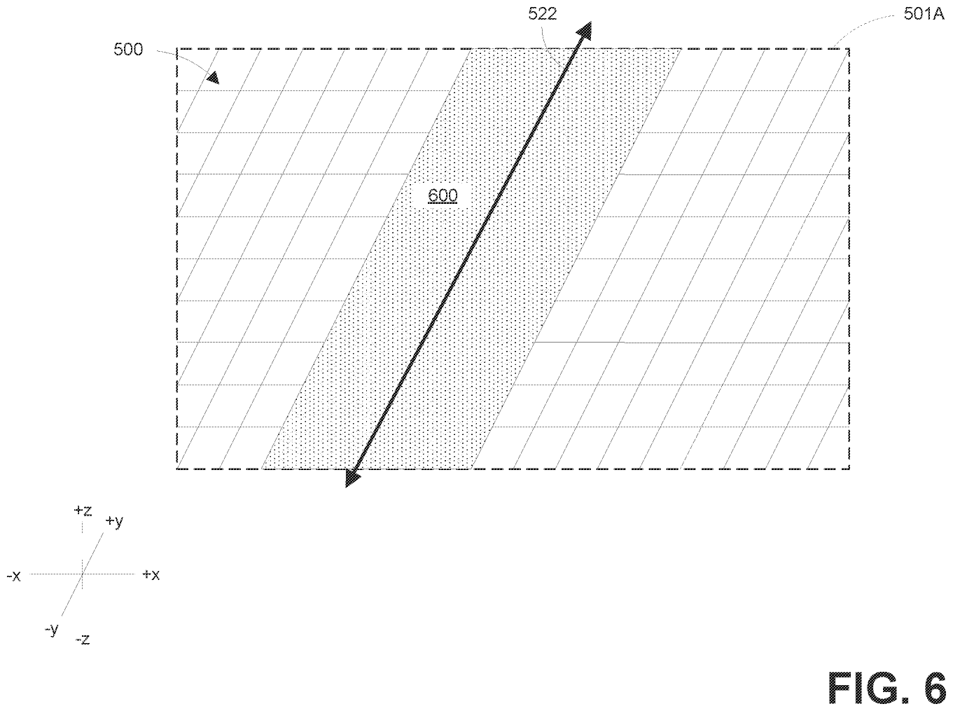

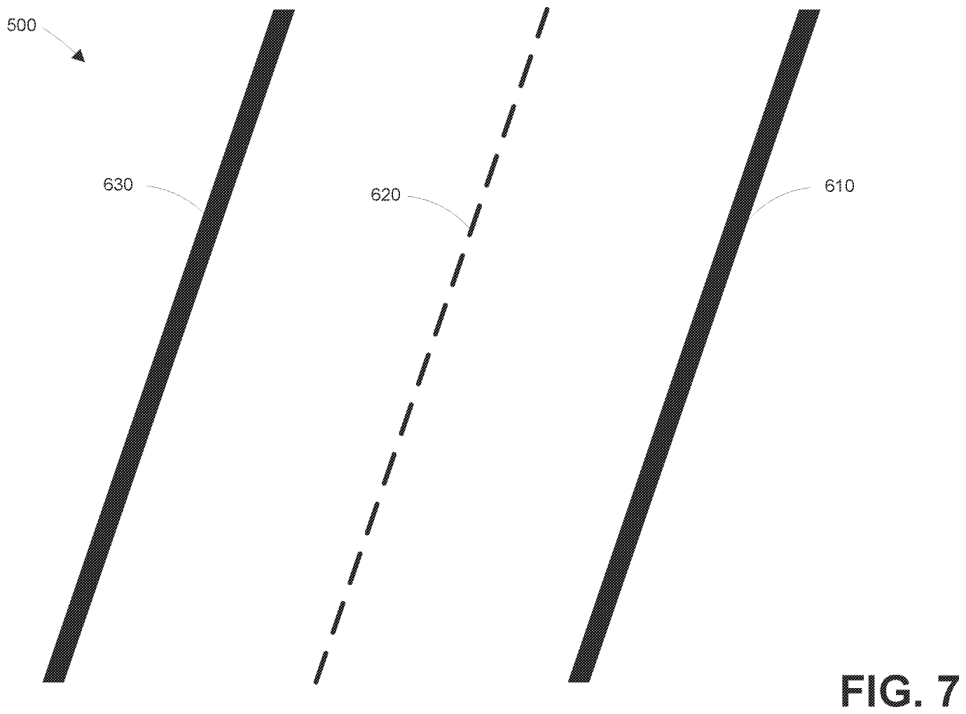

The 3D road line generation input monitor 312 (denoted in FIG. 3 as PC), in embodiments, may represent software operations that are performed on the data corresponding to the 2D image 250 and/or one or more other images obtained by the transceivers 315 and from, in embodiments, any, some, or all of the vehicle 200, the image-sensing device 202, one or more other vehicles, one or more other image-sensing devices, and/or any combination thereof. The memory component 311 may store logic (such as, in embodiments, any, some, or all of subsystems 314 for generating road lines in a 3D digital roadbed, as described elsewhere herein) which, when executed by the 3D road line generation input monitor 312, may cause the system 300 to perform any, some, or all of receiving a 2D image of a roadbed (for example, the 2D image 250 of the roadbed 210 as depicted in FIGS. 2A-2B and described in further detail elsewhere herein), identifying a plurality of road line pixels in the 2D image of the roadbed (for example, any, some, or all of the road line pixels of a plurality of road line pixels 412, as depicted in FIG. 4 and described in further detail elsewhere herein), identifying a plurality of road line 3D points (for example, any, some, or all of the road line 3D points of a plurality of road line 3D points 510, as depicted in FIGS. 5A-5B and 9A-10 and described in further detail elsewhere herein) in a 3D digital roadbed (for example, a 3D digital roadbed 500, as depicted in FIGS. 5A-7 and 9A-10) corresponding to the plurality of road line pixels of the 2D image of the roadbed, clustering at least some road line 3D points of the plurality of road line 3D points into a 3D point cloud (for example, any, some, or all of the 3D point clouds 520, 530, 540, 550, as depicted in FIGS. 5A-5B, and 9A-10 and described in further detail elsewhere herein), generating a medial axis from the 3D point cloud (for example, any, some, or all of medial axes 522, 542, 552 as depicted in FIGS. 5B, 9B, and 10 and described in further detail elsewhere herein), and generating, using the medial axis, a generated road line the 3D digital roadbed (for example, any, some, or all of generated road lines 600, 610, 620, 630, as depicted in FIGS. 6-7 and described in further detail elsewhere herein).

In embodiments, the system 300 may include a remote computing device 350. In embodiments, the remote computing device 350 may include any, some, or all of a remote memory component 351, a remote 3D road line generation input monitor 352, a remote 3D road line generation output translator 353, and one or more transceivers 355. In embodiments, the remote memory component 351 may perform and/or provide any, some, or all of the functions of the memory component 311, as described elsewhere herein, separately from, parallel to, and/or in coordination with the memory component 311. In embodiments, the remote 3D road line generation input monitor 352 may perform and/or provide any, some, or all of the functions of the 3D road line generation input monitor 312, as described elsewhere herein, separately from, parallel to, and/or in coordination with the 3D road line generation input monitor 312. Accordingly, the remote computing device 350 may be coupled (via, for example, Wi-Fi, WiMax, LTE, 4G, 5G, 6G, Bluetooth, Zigbee, and/or other wired and/or wireless connection systems) to the computing device 310 by, for example, the transceivers 315, 355, and thereby may, in embodiments, provide cloud computing functions for the computing device 310. In embodiments, the 3D road line generation output translator 353 may include any, some, or all of the subsystems 314. In embodiments, the 3D road line generation output translator 353 may conduct any, some, or all of the functions of the subsystems 314 separately from, parallel to, and/or in coordination with the subsystems 314. In embodiments, the system 300 may include only one of each of the computing devices 310, 350, or one or more of either or both of the computing devices 310, 350.

In embodiments, the remote computing device 350 may be a component of the vehicle 200, and, accordingly, in embodiments, any, some, or all of the steps of the method 100 and/or the method 102 (as depicted in FIG. 8 and described in further detail elsewhere herein) may be conducted by the remote computing device 350 and separately from, parallel to, and/or in coordination with the computing device 310. For example, in embodiments, the remote computing device 350 may be coupled (via, for example, Wi-Fi, WiMax, LTE, 4G, 5G, 6G, Bluetooth, Zigbee, and/or other wired and/or wireless connection systems) to the image-sensing device 202 and may further, in embodiments, receive outputs of the image-sensing device 202 and format the outputs of the image-sensing device 202 into the 2D image 250 (for use by, in embodiments, either or both of the computing devices 310, 350). However, in other embodiments, the vehicle 200 may include, for example, a transceiver, which transmits outputs of the image-sensing device 202 (in embodiments, in the form of the 2D image 250 and/or in another form) to either or both of the computing devices 310, 350 (via, for example, the transceivers 315).

In embodiments, the subsystems 314 and/or any, some, or all of the components thereof (for example, any, some, or all of a road line pixel identifier 314A, an image translator 314B, a 3D point cloud generator 314C, and/or a 3D digital roadbed generator 314D, as described in further detail elsewhere herein) may include and/or be configured as any, some, or all of hardware, software, and/or non-transitory computer-readable mediums (executed by, for example, either or both of the computing devices 310, 350) which may perform the functions of the subsystems 314 and/or any, some, or all of the components thereof, as described elsewhere herein.

Accordingly, referring still to FIG. 3 and with reference to FIGS. 1 and 2B, in the step of the block 110, either or both of the computing devices 310, 350 may receive the 2D image 250 of the roadbed 210. In embodiments, either or both of the computing devices 310, 350 may receive the 2D image 250 from, in embodiments, a transceiver of the vehicle 200 and/or the transceivers 355 and/or via, in embodiments, either or both of the transceivers 315, 355.

Referring again to FIG. 1 and with reference to FIGS. 2B and 4, the method 100 may include identifying a plurality of road line pixels 412 in the 2D image 250 of the roadbed 210, as described herein at block 120. FIG. 4 depicts a portion 400 of the 2D image 250, as shown in FIG. 2. In embodiments, pixels of the 2D image 250 may be defined by a lattice of a first plurality of x-lines 402 and a first plurality of y-lines 404, thereby defining a coordinate scheme of the 2D image 250. Accordingly, in embodiments, one or more pixels of the 2D image 250 may be identified as being included in the plurality of road line pixels 412, whereas one or more other pixels of the 2D image 250 may be identified as non-road line pixels, such as non-road line pixels 414, which are indicated by cross-hatching in the depiction of FIG. 4. In the embodiment of FIG. 4, the plurality of road line pixels 412 correspond to an identified road line 410. By identifying the plurality of road line pixels 412 corresponding the identified road line 410, portions of the 2D image 250 may thereby be identified as corresponding to the identified road line 410 which may, in embodiments and as described in further detail elsewhere herein, enable the 2D image 250 to be used for 3D road line generation in a 3D digital roadbed.

In the embodiment of FIG. 4, the identified road line 410 is the first shoulder road line 211. However, in other embodiments, the identified road line 410 may be any of the road lines 211, 212, 213 of the roadbed 210 or another road line of another embodiment of the roadbed 210 and/or another roadbed.

Referring to FIGS. 3 and 4, in embodiments, the identified road line 410 (and thereby, in embodiments, the plurality of road line pixels 412 corresponding thereto) may be identified by a road line pixel identifier 314A of subsystems 314 of the computing device 310. In embodiments, the road line pixel identifier 314A may comprise any, some, or all of an AI algorithm, a neural network, an image classification algorithm, an image detection algorithm, an image tagging algorithm, an image segmentation algorithm, and/or any combination thereof. In embodiments, any, some, or all of the algorithm(s) of the road line pixel identifier 314A may, in embodiments, independently and/or separately from, parallel to, and/or collectively with one or more other algorithms of the road line pixel identifier 314A (if any) identify the identified road line 410.

However, in other embodiments, the identified road line 410 (and a thereby, in embodiments, the plurality of road line pixels 412 corresponding thereto) may be identified by one or more users of the user interface 313 and received by the road line pixel identifier 314A. In certain such embodiments, the user interface 313 may thereby provide a digital and/or physical mechanism by which the user of the user interface 313 may identify the identified road line 410 (and thereby, in embodiments, the plurality of road line pixels 412 corresponding thereto) in the 2D image 250 to, in embodiments, provide an indication of the identified road line 410 (thereby, in embodiments, identifying the plurality of road line pixels 412 corresponding thereto) to the road line pixel identifier 314A and, in embodiments, the road line pixel identifier 314A may use the indication to identify the identified road line 410 (and thereby, in embodiments, the plurality of road line pixels 412 corresponding thereto).

In embodiments, a user of the user interface 313 may identify the identified road line 410 (and thereby, in embodiments, the plurality of road line pixels 412 corresponding thereto) separately from, parallel to, and/or in coordination with the road line pixel identifier 314A. Accordingly, in embodiments, the identified road line 410 (and thereby, in embodiments, the plurality of road line pixels 412 corresponding thereto) may be identified by either or both of a user of the user interface 313 and/or the road line pixel identifier 314A. For example, the user may check one or more identifications (and/or, in embodiments, a lack of identifications) made by the road line pixel identifier 314A and/or the road line pixel identifier 314A may check one or more identifications (and/or, in embodiments, a lack of identifications) made by the user.

Referring again to FIG. 1 and with reference to FIGS. 4 and 5A, the method 100 may include identifying a plurality of road line 3D points 510 in a 3D digital roadbed 500 corresponding to the plurality of road line pixels 412 of the 2D image 250 of the roadbed 210, as described herein at block 130. That is to say, the step of the block 130 includes identifying which 3D points of the 3D digital roadbed 500 correspond to the plurality of road line pixels 412 of the 2D image 250 of the roadbed 210, as, in embodiments, the 3D digital roadbed 500 may be a digital recreation of the roadbed 210. Accordingly, in embodiments, 3D points of the 3D digital roadbed 500 may be defined by a coordinate scheme such as the x-, y-, and z-coordinates depicted in a portion 501A of the 3D digital roadbed 500 as depicted in the embodiment of FIG. 5A, wherein x-values of a 3D point are indicated by a second plurality of x-lines 502, y-values of a 3D point are indicated by a second-plurality of y-lines 504, and z-values are provided by lines parallel to the z-axis (not depicted in FIG. 5A). Accordingly, in embodiments, distances between 3D points in the x-, y-, and/or z-direction(s) may represent actual distances of the roadbed 210, and so, in embodiments, each 3D point of the 3D digital roadbed 500 may represent a bound region of real space of or near the roadbed 210. In embodiments, one or more 3D points of the 3D digital roadbed 500 may be identified as being included in the plurality of road line 3D points 510, whereas one or more other 3D points of the 3D digital roadbed may be identified as non-road line 3D points, such as non-road line 3D points 512, which are indicated by cross-hatching in the depiction of FIG. 5A.

It should be understood that, in embodiments, the plurality of road line 3D points 510 may include 3D points having differing values in any, some, or all of the x-, y-, and z-directions. However, for ease of viewing and comprehending the plurality of road line 3D points 510, the embodiment of FIG. 5A depicts the 3D points of the plurality of road line 3D points 510 as having equal z-values.

Referring to FIGS. 3 and 5A, in embodiments, the plurality of road line 3D points 510 may be identified by an image translator 314B of the subsystems 314 of the computing device 310. In embodiments, the image translator 314B may comprise any, some, or all of an AI algorithm, a neural network, an image classification algorithm, an image detection algorithm, an image tagging algorithm, an image segmentation algorithm, and/or any combination thereof. In embodiments, any, some, or all of the algorithm(s) of the image translator 314B may independently and/or separately from, parallel to, and/or collectively with one or more other algorithms of the image translator 314B (if any) identify the plurality of road line 3D points 510. In embodiments, the image translator 314B may identify dozens, hundreds, or even thousands of road line 3D points of the 3D digital roadbed 500 from a single 2D image. In embodiments, the image translator 314B may identify road line 3D points from dozens, hundreds, or even thousands of 2D images corresponding to hundreds, thousands, or even millions of miles of the roadbed 210 and/or one or more other roadbed(s) in the generation of road lines in the 3D digital roadbed.

In embodiments, the image translator 314B may use localization data of the 2D image 250 to identify the plurality of road line 3D points 510. In embodiments, localization data of the 2D image 250 may include any, some, or all of data relating to a position of a viewpoint of the 2D image 250 in 3D space relative to the roadbed 210, an orientation of a viewpoint of the 2D image 250 in 3D space relative to the roadbed 210 (for example, an angle of an aperture of the image-sensing device 202 relative to a plane defined by the roadbed 210), and/or other data which may identify a location and/or viewing angle of the 2D image 250 in 3D space relative to the roadbed 210. In embodiments, a user of the user interface 313 may determine, provide, and/or input such localization device for the image translator 314B via the user interface 313. In embodiments, localization data may be generated using geospatial data of the image-sensing device 202 at, for example, a time at which the 2D image 250 was captured by the image-sensing device 202. In embodiments, geospatial data of the image-sensing device 202 may include a geospatial position and/or orientation of the image-sensing device 202 (relative to, for example, the roadbed 210). In embodiments, the image-sensing device 202 may generate geospatial data associated with the 2D image 250 and, in certain such embodiments, provide such geospatial data along with the 2D image 250 to the computing device 310. In embodiments, the image translator 314B may generate the geospatial data by applying, for example, any, some, or all of an AI algorithm, a neural network, an image classification algorithm, an image detection algorithm, an image tagging algorithm, an image segmentation algorithm, and/or any combination thereof to the 2D image 250. In embodiments, the image translator 314B may generate the geospatial data using the 2D image 250 in addition to one or more other images captured (for example, in a short period of time before and/or after the capture of the 2D image 250, such as one minute) using, for example, structure-from-motion processing techniques. However, in other embodiments, the image translator 314B and/or a user of the user interface 313 may generate the geospatial data using no other images aside from the 2D image 250.

Referring to FIGS. 2, 4, and 5A, localization data may include a distance d of the image-sensing device 202 relative to the roadbed 210 (that is to say, a height of the image-sensing device 202 in 3D space relative to the roadbed 210) and/or an angle θ of the image-sensing device 202 relative to the roadbed 210 (that is to say, an orientation of the image-sensing device 202 in 3D space relative to the roadbed 210). By using localization data, the image translator 314B may determine an angle and/or position of the 2D image 250 relative to the roadbed 210. By knowing an angle and/or position of the 2D image 250 relative to the roadbed 210, the image translator 314B may identify or approximate positions and/or regions of 3D space corresponding to the plurality of road line pixels 412 of the 2D image 250 and may, thereby, identify the plurality of road line 3D points 510 corresponding to such positions and/or regions of 3D space and, accordingly, corresponding to the plurality of road line pixels 412 of the 2D image 250. However, in embodiments, the image translator 314B may identify the plurality of road line 3D points 510 by other methods and/or mechanisms not using such localization data.

Referring again to FIGS. 3 and 5A, and with reference to FIG. 1, in embodiments, either or both of the memory components 311, 351 may store the 3D digital roadbed 500 and, in certain such embodiments, either or both of the memory components 311, 351 may already store the 3D digital roadbed 500 upon the initiation of the step of the block 130. However, in other embodiments, the step of the block 130 (or, in other embodiments, another step of either or both of the methods 100, 102) may further include receiving (by, for example, either or both of the computing devices 310, 350) one or more maps of the roadbed 210 (for example, one or more 2D maps and/or one or more 3D maps which schematically depict or otherwise represent positions of some or all of the roadbed 210 and/or one or more other roadbeds). In certain such embodiments, the step of the block 130 (or, in other embodiments, another step of either or both of the methods 100, 102) may further include generating, using the one or more map(s) of the roadbed, some or all of the 3D digital roadbed 500 and/or some or all of one or more other 3D digital roadbeds. In embodiments, the 3D digital roadbed generator 314D may generate some or all of the 3D digital roadbed 500 and/or some or all of one or more other 3D digital roadbeds. In embodiments, the 3D digital roadbed generator 314D may comprise any, some, or all of an AI algorithm, a neural network, an image classification algorithm, an image detection algorithm, an image tagging algorithm, an image segmentation algorithm, and/or any combination thereof. In embodiments, any, some, or all of the algorithm(s) of the 3D digital roadbed generator 314D may independently and/or separately from, parallel to, and/or collectively with one or more other algorithms of the 3D digital roadbed generator 314D (if any) generate some or all of the 3D digital roadbed 500 and/or some or all of one or more other 3D digital roadbeds. In embodiments, the 3D digital roadbed generator 314D may utilize dozens, hundreds, or even thousands of road maps to generate some or all of the 3D digital roadbed 500 and/or some or all of one or more other 3D digital roadbeds. In embodiments, the 3D digital roadbed generator 314D may generate one or more 3D digital roadbeds (for example, the 3D digital roadbed 500) corresponding to hundreds, thousands, or even millions of miles of one or more roadbed(s) (for example, the roadbed 210) in the generation of some or all of the 3D digital roadbed 500 and/or some or all of one or more other 3D digital roadbeds.

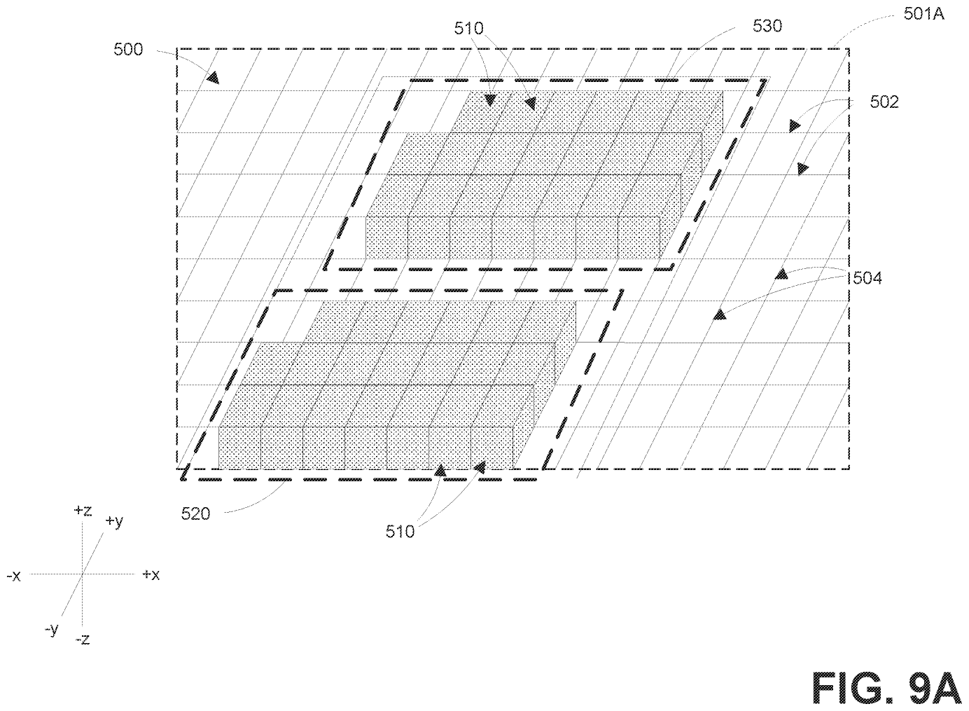

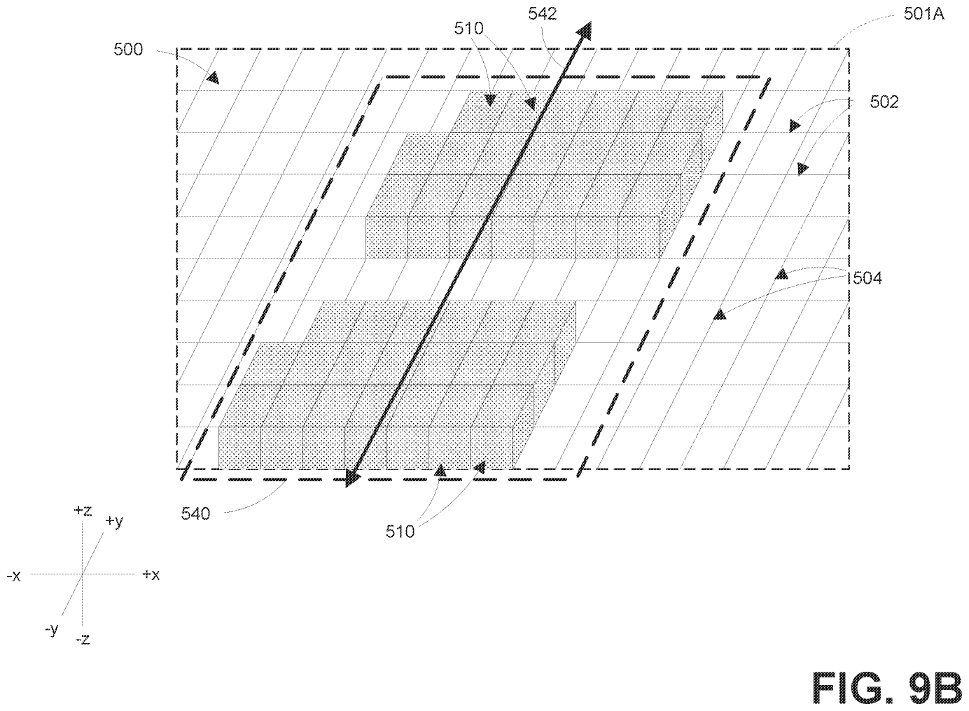

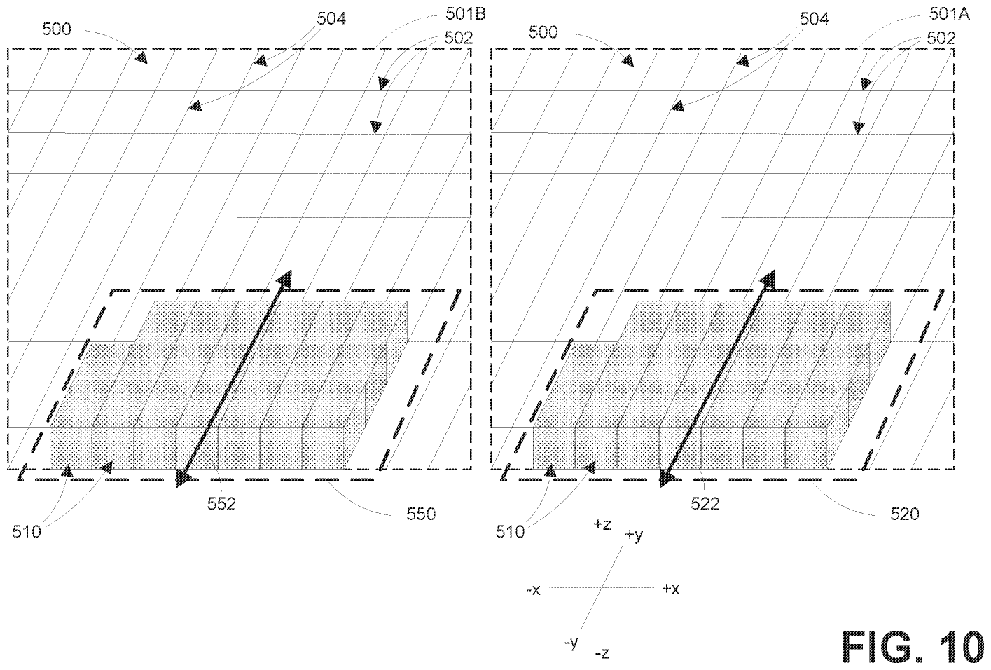

Referring again to FIG. 1 and with reference to FIG. 5B, the method 100 may include clustering at least some road line 3D points of the plurality of road line 3D points 510 into a first 3D point cloud 520, as described herein at block 140. In embodiments, such as the embodiment of FIG. 5B, the first 3D point cloud 520 (and/or, in embodiments, other 3D point clouds described elsewhere herein, such as, for example, any, some, or all of the 3D point clouds 530, 540, 550, as depicted in FIGS. 9A-10) may be a subset of the plurality of road line 3D points 510. However, in other embodiments, the first 3D point cloud 520 (and/or, in embodiments, other 3D point clouds described elsewhere herein, such as, for example, any, some, or all of the 3D point clouds 530, 540, 550, as depicted in FIGS. 9A-10) may include all of the road line 3D points of the plurality of road line 3D points 510. In embodiments, the first 3D point cloud 520 (and/or, in embodiments, other 3D point clouds described elsewhere herein, such as, for example, any, some, or all of the 3D point clouds 530, 540, 550, as depicted in FIGS. 9A-10) may include 3D points of the 3D digital roadbed 500 corresponding to a region of 3D space occupied by a portion of one of the road lines 211, 212, 213 of FIG. 2A. Accordingly, the first 3D point cloud 520 (and/or, in embodiments, other 3D point clouds described elsewhere herein, such as, for example, any, some, or all of the 3D point clouds 530, 540, 550) may be used to generate road lines in the 3D digital roadbed 500. In embodiments, generating road lines in a 3D digital roadbed may include clustering millions, billions, or even trillions of 3D points into thousands, millions, or even billions of 3D point clouds, each of which may include, in embodiments, tens, hundreds, or even thousands of 3D points.

It should be understood that, in embodiments, the first 3D point cloud 520 (and/or, in embodiments, other 3D point clouds described elsewhere herein, such as, for example, any, some, or all of the 3D point clouds 530, 540, 550) may include 3D points having differing values in any, some, or all of the x-, y-, and z-directions. However, for ease of viewing and comprehending the first 3D point cloud 520, the embodiment of FIG. 5B depicts the 3D points of the first 3D point cloud 520 as having equal z-values.

Referring to FIGS. 3 and 5B, in embodiments, the at least some road line 3D points of the plurality of road line 3D points 510 may be clustered into a 3D point cloud (for example, any, some, or all of the 3D point clouds 520, 530, 540, 550) by a 3D point cloud generator 314C of subsystems 314 of the computing device 310. In embodiments, the 3D point cloud generator 314C may comprise any, some, or all of an AI algorithm, a neural network, an image classification algorithm, an image detection algorithm, an image tagging algorithm, an image segmentation algorithm, and/or any combination thereof. In embodiments, any, some, or all of the one or more algorithms of the 3D point cloud generator 314C may independently and/or separately from, parallel to, and/or collectively with one or more other algorithms of the 3D point cloud generator 314C (if any) cluster the at least some road line 3D points of the plurality of road line 3D points 510 into a 3D point cloud (for example, any, some, or all of the 3D point clouds 520, 530, 540, 550).

However, in other embodiments, the at least some road line 3D points of the plurality of road line 3D points 510 may be clustered into a 3D point cloud (for example, any, some, or all of the 3D point clouds 520, 530, 540, 550) by one or more users of the user interface 313. In certain such embodiments, the user interface 313 may thereby provide a digital and/or physical mechanism by which the user of the user interface 313 may cluster the at least some road line 3D points of the plurality of road line 3D points 510 into a 3D point cloud (for example, any, some, or all of the 3D point clouds 520, 530, 540, 550).

In embodiments, a user of the user interface 313 may cluster the at least some road line 3D points of the plurality of road line 3D points 510 into a 3D point cloud (for example, any, some, or all of the 3D point clouds 520, 530, 540, 550) separately from, parallel to, and/or in coordination with the 3D point cloud generator 314C. Accordingly, in embodiments, the at least some road line 3D points of the plurality of road line 3D points 510 may be clustered into a 3D point cloud (for example, any, some, or all of the 3D point clouds 520, 530, 540, 550) by either or both of a user of the user interface 313 and/or the 3D point cloud generator 314C. For example, the user may check one or more 3D point clouds clustered by the 3D point cloud generator 314C and/or the 3D point cloud generator 314C may check one or more 3D point clouds clustered by the user.

Referring still to FIGS. 1 and 5B, the method 100 may include generating a first medial axis 522 from the first 3D point cloud 520, as described herein at block 150. In embodiments, the first medial axis 522 (and/or, in embodiments, other medial axes described elsewhere herein, such as either or both of the medial axes 542, 552 depicted in FIGS. 9B and 10) may be a subset of the 3D points of the first 3D point cloud 520 (and/or, in embodiments, other 3D point clouds described elsewhere herein, such as, for example, any, some, or all of the 3D point clouds 530, 540, 550). Accordingly, in embodiments, the first medial axis 522 (and/or, in embodiments, other medial axes described elsewhere herein, such as either or both of the medial axes 542, 552) may be a one-dimensional array of points. For example, in the embodiment of FIG. 5B, the first medial axis 522 includes only 3D points of the first 3D point cloud 520 having constant x- and z-values. However, in other embodiments, a medial axis (for example, any, some, or all of the medial axes 522, 542, 552) may not be a one-dimensional array of points, and may, rather and in embodiments, comprise merely a subset of the 3D points of a 3D point cloud from which the medial axis is generated extending along a length of the 3D point cloud. In embodiments, the step of the block 140 may be omitted from the method 100 and, accordingly, in such embodiments, the first medial axis 522 (and/or, in embodiments, other medial axes described elsewhere herein, such as either or both of the medial axes 542, 552) may, instead, be generated from the plurality of road line 3D points 510. In embodiments, generating the first medial axis 522 (and/or, in embodiments, other medial axes, such as either or both of the medial axes 542, 552) may include using, for example, a fitting algorithm to generate a vector in a coordinate scheme (for example, in the x/y/z coordinate scheme depicted in FIG. 5B and/or in other coordinate schemes) defining, for example, a line of best fit through the first 3D point cloud 520 (and/or, in embodiments, other 3D point clouds described elsewhere herein, such as, for example, any, some, or all of the 3D point clouds 530, 540, 550).

By first clustering at least some of the plurality of road line 3D points 510 into a 3D point cloud (for example, any, some, or all of the 3D point clouds 520, 530, 540, 550) and then generating a medial axis (for example, any, some, or all of the medial axes 522, 542, 552) from the 3D point cloud, progressively smaller subsets of the plurality of road line 3D points 510 may be generated for the generation of road lines in the 3D digital roadbed 500. Accordingly, road lines generated through such steps may, advantageously, improve accuracy of 3D positions of such generated road lines in the 3D digital roadbed 500 relative to actual 3D positions of such generated road lines' real counterparts in the roadbed 210 (for example, any, some, or all of the road lines 211, 212, 213, as depicted in FIG. 2) by, for example, increasing a precision of the generated road lines generated therefrom.

Further, either or both of clustering at least some of the plurality of road line 3D points 510 into a 3D point cloud and/or generating a medial axis from either the plurality of road line 3D points 510 or a 3D point cloud may reduce the computational complexity of generating a road line in the 3D digital roadbed 500 defined by 3D points of the 3D digital roadbed 500. Since, as described elsewhere herein, the 3D digital roadbed 500 may correspond to hundreds, thousands, or even millions of miles of the roadbed 210 and/or one or more other roadbed(s), road lines generated therein may include millions, billions, or even trillions of 3D points. Accordingly, either or both of the steps of the blocks 140, 150 may, in embodiments, reduce a computational complexity of generating road lines in the 3D digital roadbed 500. Nonetheless, in embodiments, road lines may be generated in the 3D digital roadbed 500 directly from the plurality of road line 3D points 510. Accordingly, in certain such embodiments, either or both of the steps of the blocks 140, 150 may be omitted from the method 100.

Referring to FIGS. 3 and 5B, in embodiments, a medial axis (for example, any, some, or all of the medial axes 522, 542, 552) may be generated from a 3D point cloud (for example, any, some, or all of 3D point clouds 520, 530, 540, 550) by the 3D point cloud generator 314C of subsystems 314 of the computing device 310. In embodiments, the 3D point cloud generator 314C may comprise any, some, or all of a fitting algorithm, an AI algorithm, a neural network, an image classification algorithm, an image detection algorithm, an image tagging algorithm, an image segmentation algorithm, and/or any combination thereof. In embodiments, any, some, or all of the algorithm(s) of the 3D point cloud generator 314C may independently and/or separately from, parallel to, and/or collectively with one or more other algorithms of the 3D point cloud generator 314C (if any) generate a medial axis (for example, any, some, or all of the medial axes 522, 542, 552) from a 3D point cloud (for example, any, some, or all of the 3D point clouds 520, 530, 540, 550). In embodiments, and as described elsewhere herein, generating road lines in a 3D digital roadbed may include generating thousands, millions, or even billions of medial axes from 3D point clouds including, in embodiments, tens, hundreds, or even thousands of 3D points.

However, in other embodiments, a medial axis (for example, any, some, or all of the medial axes 522, 542, 552) may be generated from a 3D point cloud (for example, any, some, or all of 3D point clouds 520, 530, 540, 550) by one or more users of the user interface 313. In certain such embodiments, the user interface 313 may thereby provide a digital and/or physical mechanism by which the user of the user interface 313 may generate a medial axis (for example, any, some, or all of the medial axes 522, 542, 552) from a 3D point cloud (for example, any, some, or all of 3D point clouds 520, 530, 540, 550).

In embodiments, a user of the user interface 313 may generate a medial axis (for example, any, some, or all of the medial axes 522, 542, 552) from a 3D point cloud (for example, any, some, or all of 3D point clouds 520, 530, 540, 550) separately from, parallel to, and/or in coordination with the 3D point cloud generator 314C. Accordingly, in embodiments, a medial axis (for example, any, some, or all of the medial axes 522, 542, 552) may be generated from a 3D point cloud (for example, any, some, or all of 3D point clouds 520, 530, 540, 550) by either or both of a user of the user interface 313 and/or the 3D point cloud generator 314C. For example, the user may check one or more medial axes generated by the 3D point cloud generator 314C and/or the 3D point cloud generator 314C may check one or more medial axes generated by the user.

Referring again to FIG. 1 and with reference to FIG. 6, the method 100 may include generating, using the first medial axis 522, a generated road line 600 in the 3D digital roadbed 500, as described herein at block 160. In embodiments, the step of the block 160 may further include, upon generating the generated road line 600, incorporating the generated road line 600 into the 3D digital roadbed 500 (for example, by modifying the 3D digital roadbed 500 to include the generated road line 600 as, for example, any of the generated road lines 610, 620, 630). In embodiments, generating the generated road line 600 may include applying a pre-determined widening distance (for example, as depicted in the embodiment of FIG. 6, two 3D points in each of the +x- and −x-directions relative to the first medial axis 522) to the first medial axis 522 (and/or, in embodiments, other medial axes described herein, such as either or both of the medial axes 542, 552, as depicted in FIGS. 9B-10). In embodiments, and as depicted in FIG. 6 with reference to FIG. 5B, generating the generated road line 600 may include extending the first medial axis 522 (and/or, in embodiments, other medial axes described herein, such as either or both of the medial axes 542, 552, as depicted in FIGS. 9B-10) beyond the first 3D point cloud 520 (and/or, in embodiments, other point clouds described herein, such as any, some, or all of the 3D point clouds 530, 540, 550, as depicted in FIGS. 9A-10) along, for example, a vector in the x-, y-, and z-coordinates of FIG. 6 defined by the first medial axis 522. Accordingly, in embodiments, the generated road line 600 may be substantially uniform.

Referring to FIGS. 3 and 6, in embodiments, the generated road line 600 may be generated from the first medial axis 522 (and/or, in embodiments, other medial axes described elsewhere herein, such as, for example, either or both of the medial axes 542, 552, as depicted in FIGS. 9B-10) by the 3D point cloud generator 314C of subsystems 314 of the computing device 310. In embodiments, the 3D point cloud generator 314C may comprise any, some, or all of a fitting algorithm, an AI algorithm, a neural network, an image classification algorithm, an image detection algorithm, an image tagging algorithm, an image segmentation algorithm, and/or any combination thereof, and any, some, or all of which may, in embodiments, independently and/or separately from, parallel to, and/or collectively with one or more other algorithms of the 3D point cloud generator 314C (if any) generate the generated road line 600 from the first medial axis 522 (and/or, in embodiments, other medial axes described elsewhere herein, such as, for example, either or both of the medial axes 542, 552, as depicted in FIGS. 9B-10).

Referring to FIGS. 1-2A and 6-7, in embodiments (such as, for example, embodiments wherein the method 100 is used to update an existing 3D digital roadbed), one or more of the generated road lines 610, 620, 630 may, prior to the initiation of the step of the block 160, previously exist in the 3D digital roadbed 500 (by, for example, being generated from a previous iteration of the method 100). For example, in embodiments, the first generated road line 610 may be a pre-existing road line, and the method 100 may be used to update the 3D digital roadbed 500 to incorporate changes to the roadbed 210 (for example, a widening of the lane 220, which included repainting the first shoulder line 211 to change a position of the first shoulder line 211). In certain such embodiments, the step of the block 160 may further include comparing the generated road line 600 to the (pre-existing) generated road line 610. In embodiments, comparing (by, for example, the 3D digital roadbed generator 314D and/or a user of the user interface 313) the generated road line 600 to the (pre-existing) generated road line 610 may include comparing one or more position(s) (in, for example, the x/y/z coordinate scheme of FIG. 6) of some or all the generated road line 600 to one or more position(s) of some or all of the (pre-existing) generated road line 610. In embodiments, upon determining that the generated road line 600 is the (pre-existing) generated road line 610 (that is to say, for example, that any, some, or all of the position(s) of the generated road line 600 are equal to or within a pre-determined deviation from any, some, or all of the position(s) of the (pre-existing) generated road line 610), the 3D digital roadbed generator 314D may not modify the 3D digital roadbed 500. In embodiments, upon determining that the generated road line 600 is not the (pre-existing) generated road line 610 (that is to say, for example, that any, some, or all of the position(s) of the generated road line 600 are not equal to or not within a pre-determined deviation from any, some, or all of the position(s) of the (pre-existing) generated road line 610), the 3D digital roadbed generator 314D may incorporate the generated road line 600 into the 3D digital roadbed 500 (by, for example, removing the (pre-existing) generated road line 610 and replacing it with the generated road line 600). Accordingly, in embodiments, the method 100 may be used to revise, update, or otherwise modify the 3D digital roadbed 500 when the 3D digital roadbed 500 already includes one or more pre-existing road lines.

Referring again to FIG. 1, any, some, or all of the steps of the method 100 may be reiterated. In embodiments, any, some, or all of the steps of the method 100 may be reiterated upon the completion of the step of the block 160. In embodiments, any, some, or all of the steps of the method 100 may be reiterated prior to and or subsequent to the iteration of a prior and/or subsequent step of the method 100 in a single iteration of the method 100. In embodiments, the method 100 may further comprise receiving an additional one or more 2D images 250 by, for example, reiterating the step of the block 110. In embodiments, the method 100 may further comprise identifying an additional one or more pluralities of road line pixels 412 by, for example, reiterating the step of the block 120. In embodiments, the method 100 may further comprise identifying an additional one or more pluralities of road line 3D points 510 by, for example, reiterating the step of the block 130. In embodiments, the method 100 may further comprise clustering at least some road line 3D points of the plurality of road line 3D points 510 into one or more additional 3D point clouds (for example, any, some, or all of the 3D point clouds 520, 530, 540, 550) by, for example, reiterating the step of the block 140. In embodiments, the method 100 may further comprise generating one or more additional medial axes (for example, any, some, or all of the medial axes 522, 542, 552) from one or more 3D point clouds (for example, any, some, or all of the 3D point clouds 520, 530, 540, 550) by, for example, reiterating the step of the block 150. In embodiments, the method 100 may further comprise generating, using the one or more medial axes, one or more additional generated road lines (for example, any, some, or all of the generated road lines 600, 610, 620, 630) in the 3D digital roadbed 500 by, for example, reiterating a step of the block 160.

Referring now to FIGS. 1-2A and 6-7, in embodiments, any, some, or all of the steps of the method 100 may be repeated any plurality of times to generate a plurality of generated road lines 600 which each form, either partially (for example, within the 3D digital roadbed portion 501A of the 3D digital roadbed 500, as depicted in FIGS. 5A-6) or wholly, generated road lines corresponding to the road lines 211, 212, 213 of the roadbed 210. For example, in embodiments, each of the steps of the blocks 110, 120, 130, 140, 150, 160 may be reiterated by receiving, in the block 110, additional individual and/or pluralities of 2D images 250 and processing the individual and/or pluralities of 2D images 250 in the steps of the blocks 120, 130, 140, 150, 160 to generate a plurality of generated road lines 600 which, collectively, form, for example, the first generated road line 610 in the 3D digital roadbed 500 corresponding to the first shoulder road line 211 of the roadbed 210. Further, in embodiments, any, some, or all of the steps of the blocks 120, 130, 140, 150, 160 of the method 100 may be reiterated using a single 2D image 250 to generate a plurality of generated road lines 600, each of which form part or all of the first generated road line 610 in addition to a second generated road line 620 (corresponding to the median road line 213 of the roadbed 210) and a third generated road line 630 (corresponding to the second shoulder road line 212 of the roadbed 210). Accordingly, in embodiments, any, some, or all of the steps of the method 100 may be reiterated upon one or more 2D images 250 to form the 3D digital roadbed 500.

For example, referring now to FIGS. 1-6, in embodiments, the step of the block 110 may be reiterated to include receiving a second 2D image 250 of the roadbed 210. Accordingly, in embodiments, each of the FIGS. 2B and 4-6 may illustrate only one iteration of one or more steps of the method 100. In embodiments, the step of the block 120 may be reiterated to include identifying a second plurality of road line pixels 412 in, in embodiments, the second 2D image 250 of the roadbed 210 wherein, in embodiments, each road line pixel of the second plurality of road line pixels 412 corresponds to a second identified road line 410 (corresponding to, for example, the median road line 213 of the roadbed 210) of the second 2D image 250. In embodiments, the step of the block 130 may be reiterated to include identifying a second plurality of road line 3D points 510 in the 3D digital roadbed 500 corresponding to the second plurality of road line pixels 412 of the second 2D image 250 of the roadbed 210. In embodiments, the step of the block 140 may be reiterated to include clustering at least some road line 3D points of the second plurality of road line 3D points 510 into a second 3D point cloud 520. In embodiments, the step of the block 150 may be reiterated to include generating a second medial axis 522 from the second 3D point cloud 520. In embodiments, the step of the block 160 may be reiterated to include generating a second generated road line 600 in the 3D digital roadbed 500. In certain such embodiments, and with reference to FIGS. 6-7, the second generated road line 600 generated from the second iteration of the method 100 (and, in embodiments, subsequent generated road lines 600 generated from subsequent iterations of the method 100) may form a portion of the same generated road line of the generated road lines 610, 620, 630 as the generated road line of the generated road lines 610, 620, 630 formed at least partially from the first generated road line 600. However, in other such embodiments, the second generated road line 600 generated from the second iteration of the method 100 (and, in embodiments, subsequent generated road lines 600 generated from subsequent iterations of the method 100) may form a portion of a different generated road line of the generated road lines 610, 620, 630 as the generated road line of the generated road lines 610, 620, 630 formed at least partially from the first generated road line 600.

Referring now to FIG. 8, in embodiments, the method 100 may be modified to include any, some, or all of steps of an illustrative method 102 for generating road lines in a 3D digital roadbed, as depicted in a flow diagram in FIG. 8. While the method 102 of FIG. 8 generally relates to use of the specific systems (for example, the system 300) and/or non-transitory computer-readable mediums (which, for example, when executed by a computing device, such as the computing device 310, may cause the computing device to execute embodiments of the method 102) described herein, it should be understood that a similar process may be used for other systems or computer-readable mediums.

In embodiments, the method 102 may include any, some, or all of the steps of blocks 110, 120, 130, 140 of the method 100, as described elsewhere herein. Referring to FIG. 8 and with reference to FIGS. 9A and 10, in embodiments, the method 102 may include (for example, after completing the step of the block 140 of the method 100) clustering at least some road line 3D points of the plurality of road line 3D points 510 into a second 3D point cloud, as described in the block 142. However, in embodiments, the second 3D point cloud generated in the step of the block 142 may either correspond to the same identified road line (for example, the identified road line 410, as depicted in FIG. 4) as the first 3D point cloud 520 or to a different road line as the first 3D point cloud 520. For example, as depicted in FIG. 9A, a second 3D point cloud 530 may be generated in the step of the block 142 which corresponds to the same identified road line as the first point 3D point cloud 520. However, as depicted in FIG. 10, a third 3D point cloud 550 may be generated in the step of the block 142 which corresponds to a different identified road line than the first 3D point cloud 520. In embodiments, the method 102 may reiterate the step of the block 142 several times, generating, in embodiments, any plurality of 3D point clouds, including, in embodiments, both of the 3D point clouds 530, 550. In embodiments, the clustering of the at least some road line 3D points of the plurality of road line 3D points 510 of the step of block 142 may be conducted by either or both of the 3D point cloud generator 314C and/or a user of the user interface 313, similarly to the manner described elsewhere herein with respect to the step of the block 140 of the method 100.

Referring to FIG. 8 and with reference to FIGS. 9A and 10, in embodiments, the method 102 may include determining whether the first 3D point cloud 520 and, in embodiments, either or both of the second 3D point cloud 530 and/or the third 3D point cloud 550 (and/or, in embodiments, one or more other 3D point clouds) correspond to the same identified road line (for example, the identified road line 410, as depicted in FIG. 4), as described in the block 144.

Referring to the embodiment of FIG. 9A, the 3D point clouds 520, 530 are both in close proximity and linearly arranged (by, for example, both being within the first 3D digital roadbed portion 501A). However, and referring to the embodiment of FIG. 10, the 3D point clouds 520, 550 are not in close proximity. For example, the first 3D point cloud 520 is in the first 3D digital roadbed portion 501A, while the third 3D point cloud 550 is in a second 3D digital roadbed portion 501B of the 3D digital roadbed 500, which is separated from the first 3D digital roadbed portion 501A by some distance. In embodiments, since the plurality of road line 3D points 510 are (for example, in the step of the block 130 of the method 100) identified as corresponding to road line pixels, each road line 3D point of the plurality of road line 3D points 510 may be associated with an identifier indicating which identified road line pixel(s) of the plurality of road line pixels 412 (as depicted in FIG. 4) each road line 3D point of the plurality of road line 3D points 510 corresponds to. Accordingly, in embodiments, such identifiers may indicate which identified road line any, some, or all of the 3D point clouds 520, 530, 550 correspond to, and may thereby be utilized in the step of the block 144. However, in embodiments, identification of which identified road line any, some, or all of the 3D point clouds 520, 530, 550 correspond to may be conducted another way, such as, for example, by the 3D point cloud generator 314C and/or by a user of the user interface 313.

Referring to FIG. 8 and with reference to FIG. 9B, in embodiments, the method 102 may include, upon determining, in the step of the block 144, that the first 3D point cloud 520 and the second 3D point cloud 530 (and/or, in embodiments, one or more other 3D point clouds) correspond to the same identified road line (for example, the identified road line 410, as depicted in FIG. 4), combining the first 3D point cloud 520 and the second 3D point cloud 530 (and/or, in embodiments, one or more other 3D point clouds, such as any plurality of 3D point clouds) to form a combined 3D point cloud 540, as described in the block 146. While the combined 3D point cloud 540, in the embodiment of FIG. 9B, includes only the two point clouds 520, 530, in other embodiments, the combined 3D point cloud 540 may include any plurality of 3D point clouds.

In embodiments, the step of the block 146 may be conducted with one or more 3D point clouds generated from the same 2D image 250. However, in other embodiments, the step of the block 146 may be conducted with one or more 3D point clouds each generated from a plurality of the 2D images 250. In certain such embodiments, there may be discontinuities between 3D point clouds generated therefrom as, for example, the 2D images 250 may be taken at a time interval which makes the generation of a continuous array of road line 3D points 510 difficult, thereby making (in, for example, embodiments of the step of the block 140 of the method 100) either, in embodiments, separately clustered 3D point clouds (for example, the 3D point clouds 520, 530) or 3D point clouds which may not, initially, be clustered into a single 3D point cloud (for example, the combined 3D point cloud 540). In embodiments, the first 3D point cloud 520 may be combined with the second 3D point cloud 530 (and/or, in embodiments, one or more other 3D point clouds) by either or both of the 3D point cloud generator 314C and/or by a user of the user interface 313.

Referring to FIG. 8 and with reference to FIG. 9B, in embodiments, the method 102 may include, upon combining, in the step of the block 146, the first 3D point cloud 520 and the second 3D point cloud 530 (and/or, in embodiments, one or more other 3D point clouds) to form the combined 3D point cloud 540, generating a combined medial axis 542 from the combined 3D point cloud 540, as described in the block 152A. In embodiments, the generation of the combined medial axis 542 may be conducted similarly to the generation of the first medial axis 122, as described elsewhere herein. In embodiments, the combined medial axis 542 may be generated by either or both of the 3D point cloud generator 314C and/or a user of the user interface 313.

Referring to FIG. 8 and with reference to FIGS. 6, 7, and 9B, in embodiments, the method 102 may include, upon generating the combined medial axis 542, generating, using the combined medial axis 542, the generated road line 600 in the 3D digital roadbed 500, as described in block 160. In embodiments, the step of the block 160 may further include, upon generating the generated road line 600, incorporating (by, for example, the 3D digital roadbed generator 314D and/or a user of the user interface 313) the generated road line 600 into the 3D digital roadbed 500 (for example, by modifying the 3D digital roadbed 500 to include the generated road line 600 as, for example, any of the generated road lines 610, 620, 630). In embodiments, the generated road line 600 may be any, some, or all of the generated road lines 610, 620, 630 and/or another generated road line. In embodiments, generating the generated road line 600 from the combined medial axis 542 may function similarly to generating the generated road line 600 from the first medial axis 522 in the step of the block 160 of the method 100, as described elsewhere herein. In embodiments, the generated road line 600 may be generated from the combined medial axis 542 by either or both of the 3D point cloud generator 314C and/or a user of the user interface 313.

Referring to FIGS. 2A and 6-8, in embodiments (such as, for example, embodiments wherein the method 102 is used to update an existing 3D digital roadbed), one or more of the generated road lines 610, 620, 630 may, prior to the initiation of the step of the block 160, previously exist in the 3D digital roadbed 500 (by, for example, being generated from a previous iteration of the method 100 and/or the method 102). For example, in embodiments, the first generated road line 610 may be a pre-existing road line, and the method 102 may be used to update the 3D digital roadbed 500 to incorporate changes to the roadbed 210 (for example, a widening of the lane 220, which included repainting the first shoulder line 211 to change a position of the first shoulder line 211). In certain such embodiments, the step of the block 160 may further include comparing (by, for example, the 3D digital roadbed generator 314D and/or a user of the user interface 313) the generated road line 600 to the (pre-existing) generated road line 610. In embodiments, comparing the generated road line 600 to the (pre-existing) generated road line 610 may include comparing one or more position(s) (in, for example, the x/y/z coordinate scheme of FIG. 6) of some or all the generated road line 600 to one or more position(s) of some or all of the (pre-existing) generated road line 610. In embodiments, upon determining that the generated road line 600 is the (pre-existing) generated road line 610 (that is to say, for example, that any, some, or all of the position(s) of the generated road line 600 are equal to or within a pre-determined deviation from any, some, or all of the position(s) of the (pre-existing) generated road line 610), the 3D digital roadbed generator 314D may not modify the 3D digital roadbed 500. In embodiments, upon determining that the generated road line 600 is not the (pre-existing) generated road line 610 (that is to say, for example, that any, some, or all of the position(s) of the generated road line 600 are not equal to or not within a pre-determined deviation from any, some, or all of the position(s) of the (pre-existing) generated road line 610), the 3D digital roadbed generator 314D may incorporate the generated road line 600 into the 3D digital roadbed 500 (by, for example, removing the (pre-existing) generated road line 610 and replacing it with the generated road line 600). Accordingly, in embodiments, the method 102 may be used to revise, update, or otherwise modify the 3D digital roadbed 500 when the 3D digital roadbed 500 already includes one or more pre-existing road lines.

Referring to FIG. 8 and with reference to FIG. 10, in embodiments, the method 102 may include, upon determining, in the step of the block 144, that the first 3D point cloud 520 and the second 3D point cloud 530 (and/or, in embodiments, one or more other 3D point clouds) correspond to different identified road lines (for example, the identified road line 410, as depicted in FIG. 4), generating the first medial axis 522 from the first 3D point cloud 520, as described in block 150. In embodiments, the step of the block 150 of the method 102 may function similarly to the step of the block 150 of the method 100, as described elsewhere herein, and, in embodiments, may be followed by the step of the block 160, as also described elsewhere herein.

Referring to FIG. 8 and with reference to FIG. 10, in embodiments, the method 102 may include, upon determining, in the step of the block 144, that the first 3D point cloud 520 and the second 3D point cloud 530 (and/or, in embodiments, one or more other 3D point clouds) correspond to different identified road lines (for example, the identified road line 410, as depicted in FIG. 4), generating a second medial axis 552 from the second 3D point cloud 550, as described in block 152B. In embodiments, the step of the block 152B may function similarly to the step of the block 150 of the method 100, as described elsewhere herein. In embodiments, the second medial axis 552 may be generated by either or both of the 3D point cloud generator 314C and/or a user of the user interface 313.

Referring to FIG. 8 and with reference to FIGS. 6, 7, and 10, in embodiments, the method 102 may include, upon generating the second medial axis 552, generating, using the second medial axis 552, the generated road line 600 in the 3D digital roadbed 500, as described in block 162. In embodiments, the step of the block 162 may further include, upon generating the generated road line 600, incorporating (by, for example, the 3D digital roadbed generator 314D and/or a user of the user interface 313) the generated road line 600 into the 3D digital roadbed 500 (for example, by modifying the 3D digital roadbed 500 to include the generated road line 600 as, for example, any of the generated road lines 610, 620, 630). In embodiments, the generated road line 600 may be any, some, or all of the generated road lines 610, 620, 630 and/or another generated road line. In embodiments, generating the generated road line 600 from the second medial axis 552 may function similarly to generating the generated road line 600 from the first medial axis 522 in the step of the block 160 of the method 100, as described elsewhere herein. In embodiments, the generated road line 600 may be generated from the second medial axis 552 by either or both of the 3D point cloud generator 314C and/or a user of the user interface 313.

Referring to FIGS. 2A and 6-8, in embodiments (such as, for example, embodiments wherein the method 102 is used to update an existing 3D digital roadbed), one or more of the generated road lines 610, 620, 630 may, prior to the initiation of the step of the block 162, previously exist in the 3D digital roadbed 500 (by, for example, being generated from a previous iteration of the method 100 and/or the method 102). For example, in embodiments, the first generated road line 610 may be a pre-existing road line, and the method 102 may be used to update the 3D digital roadbed 500 to incorporate changes to the roadbed 210 (for example, a widening of the lane 220, which included repainting the first shoulder line 211 to change a position of the first shoulder line 211). In certain such embodiments, the step of the block 162 may further include comparing (by, for example, the 3D digital roadbed generator 314D and/or a user of the user interface 313) the generated road line 600 to the (pre-existing) generated road line 610. In embodiments, comparing the generated road line 600 to the (pre-existing) generated road line 610 may include comparing one or more position(s) (in, for example, the x/y/z coordinate scheme of FIG. 6) of some or all the generated road line 600 to one or more position(s) of some or all of the (pre-existing) generated road line 610. In embodiments, upon determining that the generated road line 600 is the (pre-existing) generated road line 610 (that is to say, for example, that any, some, or all of the position(s) of the generated road line 600 are equal to or within a pre-determined deviation from any, some, or all of the position(s) of the (pre-existing) generated road line 610), the 3D digital roadbed generator 314D may not modify the 3D digital roadbed 500. In embodiments, upon determining that the generated road line 600 is not the (pre-existing) generated road line 610 (that is to say, for example, that any, some, or all of the position(s) of the generated road line 600 are not equal to or not within a pre-determined deviation from any, some, or all of the position(s) of the (pre-existing) generated road line 610), the 3D digital roadbed generator 314D may incorporate the generated road line 600 into the 3D digital roadbed 500 (by, for example, removing the (pre-existing) generated road line 610 and replacing it with the generated road line 600). Accordingly, in embodiments, the method 102 may be used to revise, update, or otherwise modify the 3D digital roadbed 500 when the 3D digital roadbed 500 already includes one or more pre-existing road lines.

Referring again to FIG. 8, and as described elsewhere herein with respect to the method 100, any, some, or all of the steps of the method 102 may be reiterated. In embodiments, any, some, or all of the steps of the method 102 may be reiterated upon the completion of the step of the block 160 and/or of the step of the block 162. In embodiments, any, some, or all of the steps of the method 102 may be reiterated prior to and or subsequent to the iteration of a prior and/or subsequent step of the method 102 in a single iteration of the method 102. In embodiments, the method 102 may further comprise receiving an additional one or more 2D images 250 by, for example, reiterating the step of the block 110. In embodiments, the method 102 may further comprise identifying an additional one or more pluralities of road line pixels 412 by, for example, reiterating the step of the block 120. In embodiments, the method 102 may further comprise identifying an additional one or more pluralities of road line 3D points 510 by, for example, reiterating the step of the block 130. In embodiments, the method 102 may further comprise clustering at least some road line 3D points of the plurality of road line 3D points 510 into one or more additional first 3D point clouds (for example, any, some, or all of the 3D point clouds 520, 530, 540, 550) by, for example, reiterating the step of the block 140. In embodiments, the method 102 may further comprise clustering at least some road line 3D points of the plurality of road line 3D points 510 into one or more additional second 3D point clouds (for example, any, some, or all of the 3D point clouds 520, 530, 540, 550) by, for example, reiterating the step of the block 142. In embodiments, the method 102 may further comprise one or more additional determinations of whether two or more 3D point clouds (for example, any, some, or all of the 3D point clouds 520, 530, 540, 550) correspond to the same identified road line (for example, the identified road line 410) by, for example, reiterating the step of the block 144. In embodiments, the method 102 may further comprise combining one or more 3D point clouds (for example, any, some, or all of the 3D point clouds 520, 530, 540, 550) to form an additional one or more combined 3D point clouds (for example, the combined 3D point cloud 540) by, for example, reiterating a step of the block 146. In embodiments, the method 102 may further comprise generating an additional one or more medial axes (for example, the combined medial axis 542) by, for example, reiterating a step of the block 152A. In embodiments, the method 102 may further comprise generating, using the one or more combined medial axes, one or more additional generated road lines (for example, any, some, or all of the generated road lines 600, 610, 620, 630) in the 3D digital roadbed 500 by, for example, reiterating a step of the block 160. In embodiments, the method 102 may further comprise generating one or more additional first medial axes (for example, any, some, or all of the medial axes 522, 542, 552) from one or more 3D point clouds (for example, any, some, or all of the 3D point clouds 520, 530, 540, 550) by, for example, reiterating the step of the block 150. In embodiments, the method 102 may further comprise generating, using the one or more first medial axes, one or more additional first generated road lines (for example, any, some, or all of the generated road lines 600, 610, 620, 630) in the 3D digital roadbed 500 by, for example, reiterating a step of the block 160. In embodiments, the method 102 may further comprise generating one or more additional second medial axes (for example, any, some, or all of the medial axes 522, 542, 552) from one or more 3D point clouds (for example, any, some, or all of the 3D point clouds 520, 530, 540, 550) by, for example, reiterating the step of the block 152B. In embodiments, the method 102 may further comprise generating, using the one or more second medial axes, one or more additional second generated road lines (for example, any, some, or all of the generated road lines 600, 610, 620, 630) in the 3D digital roadbed 500 by, for example, reiterating a step of the block 162.

In the embodiment of FIG. 8, the method 102 is depicted as either generating the generated road line 600 from the combined medial axis 542 or generating one or more generated road lines 600 from the first medial axis 522 and the second medial axis 552. However, in embodiments, the method 10 the may include the generation of any, some, or all of the combined medial axis 552, the first medial axis 522, and the second medial axis 552, and, in embodiments, the generation of one or more generated road lines 600 therefrom.

It should now be understood that the present disclosure relates to various systems, methods, and non-transitory computer-readable mediums for generating road lines in a 3D digital roadbed.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims coverall such changes and modifications that are within the scope of the claimed subject matter.

What is claimed is:

1. A method for generating road lines in a three-dimensional digital roadbed, the method comprising:
receiving a first two-dimensional image of a roadbed;
identifying a first plurality of road line pixels in the first two-dimensional image of the roadbed, wherein each road line pixel of the first plurality of road line pixels corresponds to an identified road line of the first two-dimensional image;
identifying a first plurality of road line three-dimensional points in the three-dimensional digital roadbed corresponding to the first plurality of road line pixels of the first two-dimensional image of the roadbed;
clustering at least some road line three-dimensional points of the first plurality of road line three-dimensional points into a first three-dimensional point cloud;
generating a first medial axis from the first three-dimensional point cloud; and
generating, using the first medial axis, a first generated road line in the three-dimensional digital roadbed.

2. The method of claim 1, further comprising clustering at least some road line three-dimensional points of the first plurality of road line three-dimensional points into a second three-dimensional point cloud.

3. The method of claim 2, wherein:
the method further comprises combining the first three-dimensional point cloud and the second three-dimensional point cloud to form a combined three-dimensional point cloud; and
the first medial axis is generated from the combined three-dimensional point cloud.

4. The method of claim 2, further comprising:
generating a second medial axis from the second three-dimensional point cloud; and
generating, using the second medial axis, a second generated road line in the three-dimensional digital roadbed.

5. The method of claim 1, further comprising:
receiving a second two-dimensional image of the roadbed;
identifying a second plurality of road line pixels in the second two-dimensional image of the roadbed, wherein each road line pixel of the second plurality of road line pixels corresponds to an identified road line of the second two-dimensional image;
identifying a second plurality of road line three-dimensional points in the three-dimensional digital roadbed corresponding to the second plurality of road line pixels of the second two-dimensional image of the roadbed;
clustering at least some road line three-dimensional points of the second plurality of road line three-dimensional points into a second three-dimensional point cloud;
generating a second medial axis from the second three-dimensional point cloud; and
generating, using the second medial axis, a second generated road line in the three-dimensional digital roadbed.

6. The method of claim 1, further comprising generating, using geospatial data of an image-sensing device which captured the first two-dimensional image of the roadbed, localization data of the first two-dimensional image of the roadbed, wherein the identifying of the first plurality of road line three-dimensional points in the three-dimensional digital roadbed includes using the localization data of the first two-dimensional image of the roadbed.

7. The method of claim 1, wherein the identifying of the first plurality of road line pixels in the first two-dimensional image of the roadbed includes:
identifying, by a road line pixel identifier, the identified road line of the first two-dimensional image, wherein the road line pixel identifier comprises an AI algorithm, a neural network, an image classification algorithm, an image detection algorithm, an image tagging algorithm, an image segmentation algorithm, or any combination thereof;
identifying, by a user using a user interface, the identified road line of the first two-dimensional image; or
any combination thereof.

8. The method of claim 1, further comprising:
receiving a map of the roadbed; and
generating, using the map of the roadbed, the three-dimensional digital roadbed.

9. The method of claim 1, further comprising:
comparing the first generated road line to a pre-existing road line of the three-dimensional digital roadbed; and
upon determining that the first generated road line is not the pre-existing road line, incorporating the first generated road line into the three-dimensional digital roadbed.

10. The method of claim 1, further comprising incorporating the first generated road line into the three-dimensional digital roadbed.

11. A system for generating road lines in a three-dimensional digital roadbed, the system comprising:
a memory component which stores a first two-dimensional image of a roadbed and the three-dimensional digital roadbed;
a road line pixel identifier which identifies a first plurality of road line pixels in the first two-dimensional image of the roadbed, wherein each road line pixel of the first plurality of road line pixels corresponds to an identified road line of the first two-dimensional image;
an image translator which identifies a first plurality of road line three-dimensional points in the three-dimensional digital roadbed corresponding to the first plurality of road line pixels of the first two-dimensional image of the roadbed; and
a three-dimensional point cloud generator which performs at least the following:
clustering at least some road line three-dimensional points of the first plurality of road line three-dimensional points into a first three-dimensional point cloud,
generating a first medial axis from the first three-dimensional point cloud, and
generating, using the first medial axis, a first generated road line in the three-dimensional digital roadbed.

12. The system of claim 11, wherein the three-dimensional point cloud generator further performs clustering at least some road line three-dimensional points of the first plurality of road line three-dimensional points into a second three-dimensional point cloud.

13. The system of claim 12, wherein:
the three-dimensional point cloud generator further performs combining the first three-dimensional point cloud and the second three-dimensional point cloud to form a combined three-dimensional point cloud; and
the three-dimensional point cloud generator generates the first medial axis from the combined three-dimensional point cloud.

14. The system of claim 12, wherein the three-dimensional point cloud generator further performs:
generating a second medial axis from the second three-dimensional point cloud; and
generating, using the second medial axis, a second generated road line in the three-dimensional digital roadbed.

15. The system of claim 11, wherein:
the memory component further stores a second two-dimensional image of the roadbed;
the road line pixel identifier further identifies a second plurality of road line pixels in the second two-dimensional image of the roadbed, wherein each road line pixel of the second plurality of road line pixels corresponds to an identified road line of the second two-dimensional image;
the image translator further identifies a second plurality of road line three-dimensional points in the three-dimensional digital roadbed corresponding to the second plurality of road line pixels of the second two-dimensional image of the roadbed; and
the three-dimensional point cloud generator further performs at least the following:
clustering at least some road line three-dimensional points of the second plurality of road line three-dimensional points into a second three-dimensional point cloud,
generating a second medial axis from the second three-dimensional point cloud, and
generating, using the second medial axis, a second generated road line in the three-dimensional digital roadbed.

16. The system of claim 11, wherein the image translator generates, using geospatial data of an image-sensing device which captured the first two-dimensional image of the roadbed, localization data of the first two-dimensional image of the roadbed, and wherein the image translator uses the localization data of the first two-dimensional image of the roadbed to identify the first plurality of road line three-dimensional points in the three-dimensional digital roadbed.

17. The system of claim 11, wherein:
the road line pixel identifier identifies the identified road line of the first two-dimensional image and comprises an AI algorithm, a neural network, an image classification algorithm, an image detection algorithm, an image tagging algorithm, an image segmentation algorithm, or any combination thereof;
the system further comprises a user interface and the road line pixel identifier receives, from a user using the user interface of the system, an indication of the road line of the first two-dimensional image and wherein the road line pixel identifier uses the indication to identify the identified road line; or
any combination thereof.

18. The system of claim 11, further comprising a three-dimensional digital roadbed generator, wherein:
the memory component further stores a map of the roadbed; and
the three-dimensional digital roadbed generator generates, using the map of the roadbed, the three-dimensional digital roadbed.

19. The system of claim 11, further comprising a three-dimensional digital roadbed generator, wherein:
the three-dimensional digital roadbed generator compares the first generated road line to a pre-existing road line of the three-dimensional digital roadbed; and
upon determining that the first generated road line is not the pre-existing road line, the three-dimensional digital roadbed generator incorporates the first generated road line into the three-dimensional digital roadbed.

20. The system of claim 11, further comprising a three-dimensional digital roadbed generator which incorporates the first generated road line into the three-dimensional digital roadbed.
